(19) United States
(12) Patent Application Publication
(10) Pub. No.: US 2016/0072634 A1
(43) Pub. Date: Mar. 10, 2016

(54) HEADER COMPACTION FOR OPTIMIZED PROCESSING AND RETRANSMISSION OF TUNNELED MULTICAST DATA FOR AN EMBMS CLIENT DISTRIBUTED ARCHITECTURE

(71) Applicant: QUALCOMM Incorporated, San Diego, CA (US)

(72) Inventors: Mateen Majeed KHAN, San Diego, CA (US); Ralph Akram GHOLMIEH, San Diego, CA (US); Ankur VERMA, San Diego, CA (US); Thadi Manjunath NAGARAJ, San Diego, CA (US); Prabhu Ramani IYER, San Diego, CA (US)

(21) Appl. No.: 14/836,809

(22) Filed: Aug. 26, 2015

Related U.S. Application Data
(60) Provisional application No. 62/046,882, filed on Sep. 5, 2014.

(51) Int. Cl. H04L 12/18; H04L 29/12; H04L 29/06; H04W 72/00

(52) U.S. Cl. CPC H04L 12/189; H04W 72/005; H04L 61/2007; H04L 69/22

(57) ABSTRACT

In an aspect of the disclosure, a method, a computer-readable medium, and an apparatus are provided. The apparatus may be a UE. The UE receives an IP packet including header information and data for a MBMS session. The header information includes only information indicating at least one of an IP version, a destination multicast address of the IP packet, or a destination multicast port of the IP packet. The UE generates a multicast datagram including the data. The multicast datagram is generated based on at least one of the information indicating the destination multicast address or the information indicating the destination multicast port. The UE sends the multicast datagram to an application running on the UE.

### CROSS-REFERENCE TO RELATED APPLICATION(S)

This application claims the benefit of U.S. Provisional Application Ser. No. 62/046,882, entitled “HEADER COMPACTION FOR OPTIMIZED PROCESSING AND RETRANSMISSION OF TUNNELED MULTICAST DATA FOR AN EMBMS CLIENT DISTRIBUTED ARCHITECTURE” and filed on Sep. 5, 2014, which is expressly incorporated by reference herein in its entirety.

### BACKGROUND

1. Field

The present disclosure relates generally to communication systems, and more particularly, to techniques of header compaction for optimized processing and retransmission of tunneled multicast data for an evolved Multimedia Broadcast Multicast Service (eMBMS) client distributed architecture.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

The following presents a simplified summary of one or more aspects of the present disclosure in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, according to an example, a method of wireless communication of a user equipment (UE) is provided. The method includes receiving an Internet protocol (IP) packet including header information and data for a Multimedia Broadcast Multicast Service (MBMS) session. The header information includes only information indicating at least one of an IP version, a destination multicast address of the IP packet, or a destination multicast port of the IP packet. The method includes generating a multicast datagram including the data. The multicast datagram is generated based on at least one of the information indicating the destination multicast address or the information indicating the destination multicast port. The method includes sending the multicast datagram to an application running on the UE.

According to an example, an apparatus for wireless communication is provided. The apparatus may be a UE. The apparatus includes means for receiving an IP packet including header information and data for a MBMS session. The header information includes only information indicating at least one of an IP version, a destination multicast address of the IP packet, or a destination multicast port of the IP packet. The apparatus includes means for generating a multicast datagram including the data. The multicast datagram is generated based on at least one of the information indicating the destination multicast address or the information indicating the destination multicast port. The apparatus includes means for sending the multicast datagram to an application running on the UE.

According to an example, an apparatus for wireless communication is provided. The apparatus may be a UE. The apparatus includes a memory and at least one processor coupled to the memory and configured to receive an IP packet including header information and data for a MBMS session. The header information includes only information indicating at least one of an IP version, a destination multicast address of the IP packet, or a destination multicast port of the IP packet. The at least one processor is further configured to generate a multicast datagram including the data. The multicast datagram is generated based on at least one of the information indicating the destination multicast address or the information indicating the destination multicast port. The at least one processor is further configured to send the multicast datagram to an application running on the UE.

According to an example, a computer-readable medium storing computer executable code for wireless communication at a UE is provided. The computer-readable medium includes code for receiving an IP packet including header information and data for a MBMS session. The header information includes only information indicating at least one of an IP version, a destination multicast address of the IP packet, or a destination multicast port of the IP packet. The computer-readable medium includes code for generating a multicast datagram including the data. The multicast datagram is generated based on at least one of the information indicating the destination multicast address or the information indicating the destination multicast port. The computer-readable medium includes code for sending the multicast datagram to an application running on the UE.

In another aspect, according to an example, a method of wireless communication of an apparatus is provided. The method includes receiving a first IP packet including IP header information and data, the IP header information including an IP version, a destination multicast address, and a destination multicast port. The method includes generating a second IP packet including header information and the data, the header information including only information indicating at least one of the IP version, the destination multicast address, or the destination multicast port. The method includes sending the second IP packet to a UE based on the destination multicast address and the destination multicast port. In certain configurations, the header information is generated to include only the destination multicast address, the destination multicast port, and the IP version. In certain configurations, the header information is generated to include only the destination multicast port. In certain configurations, the header information is generated to include only the destination multicast address and the destination multicast port.

In certain configurations, the method may include determining at least one identifier based on a mapping from the destination multicast port to a set of identifiers. The header information is generated to include the at least one identifier. In certain configurations, the method may also include determining at least one identifier based on a mapping from the destination multicast address and the destination multicast port to a set of identifiers. The header information is generated to include the at least one identifier. In certain configurations, the method may further include determining at least one identifier based on a mapping from the destination multicast address, the destination multicast port, and the IP version to a set of identifiers. The header information is generated to include the at least one identifier. In certain configurations, the information indicating the destination multicast port is a TEID based on a GPRS tunneling protocol. In certain configurations, the method may include sending mapping information to the UE. The mapping information includes a mapping from at least one of the IP version, the destination multicast address, or the destination multicast port to a set of identifiers.

According to an example, an apparatus for wireless communication is provided. The apparatus includes means for receiving an IP packet including IP header information and data, the IP header information including an IP version, a destination multicast address, and a destination multicast port. The apparatus includes means for generating a second IP packet including header information and the data, the header information including only information indicating at least one of the IP version, the destination multicast address, or the destination multicast port. The apparatus includes means for sending the second IP packet to a UE based on the destination multicast address and the destination multicast port.

According to an example, an apparatus for wireless communication is provided. The apparatus includes a memory and at least one processor coupled to the memory and configured to receive an IP packet including IP header information and data, the IP header information including an IP version, a destination multicast address, and a destination multicast port. The at least one processor is further configured to generate a second IP packet including header information and the data, the header information including only information indicating at least one of the IP version, the destination multicast address, or the destination multicast port. The at least one processor is further configured to send the second IP packet to a UE based on the destination multicast address and the destination multicast port.

According to an example, a computer-readable medium storing computer executable code for wireless communication at an apparatus is provided. The computer-readable medium includes code for receiving a first IP packet including IP header information and data, the IP header information including an IP version, a destination multicast address, and a destination multicast port. The computer-readable medium includes code for generating a second IP packet including header information and the data, the header information including only information indicating at least one of the IP version, the destination multicast address, or the destination multicast port. The computer-readable medium includes code for sending the second IP packet to a UE based on the destination multicast address and the destination multicast port.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7A is a diagram illustrating an example of an evolved Multimedia Broadcast Multicast Service (eMBMS) channel configuration in a Multicast Broadcast Single Frequency Network.

FIG. 7B is a diagram illustrating a format of a Multicast Channel Scheduling Information Media Access Control control element.

FIG. 8 is a diagram illustrating an exemplary distributed eMBMS client architecture.

FIG. 9 is a diagram illustrating one format of a tunneled packet in accordance with a technique for distributing eMBMS multicast services.

FIG. 10 is a diagram illustrating another format of a tunneled packet in accordance with a technique for distributing eMBMS multicast services.

FIG. 11 is a diagram illustrating another format of a tunneled packet in accordance with a technique for distributing eMBMS multicast services.

FIG. 12 is a diagram illustrating another format of a tunneled packet in accordance with a technique for distributing eMBMS multicast services.

FIG. 13 is a diagram illustrating another format of a tunneled packet in accordance with a technique for distributing eMBMS multicast services.

FIG. 14 is a flow chart of a method of wireless communication.

FIG. 15 is a flow chart of a method of wireless communication.

FIG. 16 is a conceptual data flow diagram illustrating the data flow between different modules/means/components in an exemplary apparatus.

FIG. 17 is a conceptual data flow diagram illustrating the data flow between different modules/means/components in an exemplary apparatus.

FIG. 18 is a diagram illustrating an example of a hardware implementation for an apparatus employing a processing system.

FIG. 19 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

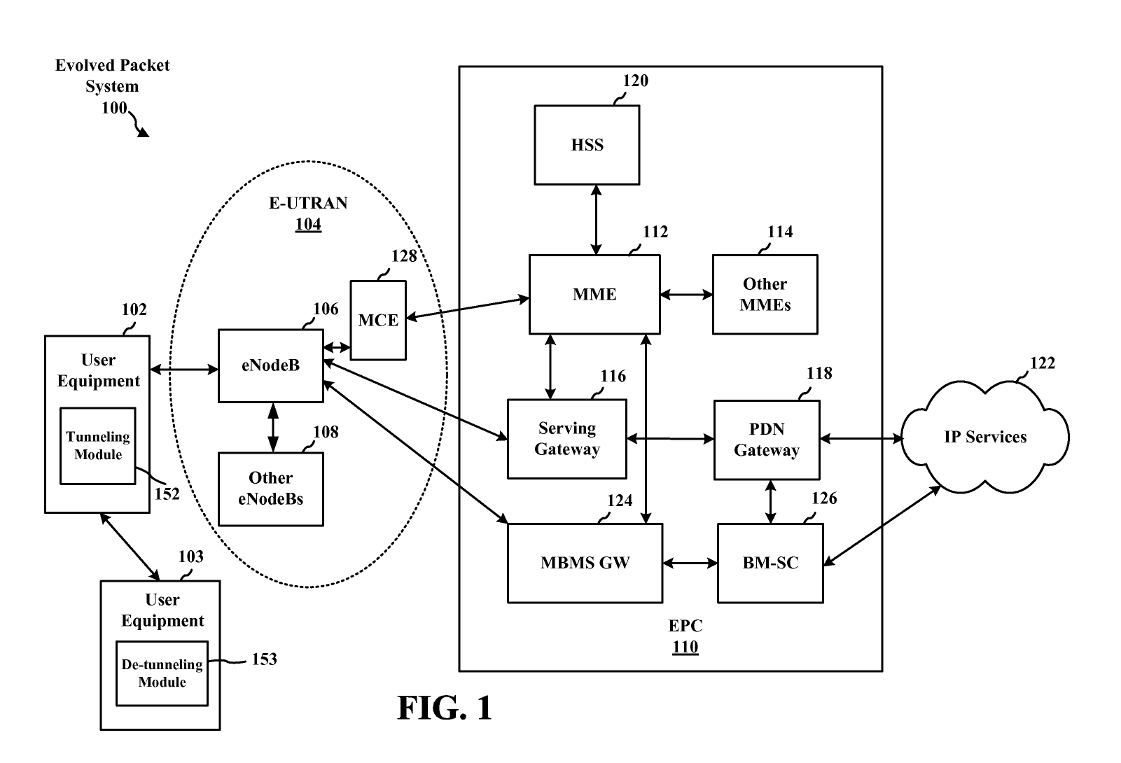

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

In certain configurations, the UE 102 is in communication with a UE 103 in a local or private network. The UE 102 includes a tunneling module 152. The tunneling module 152 may control a process of receiving a first IP packet which can include IP header information and data from the eNB 106. The IP header information may include an IP version, a destination multicast address, a destination multicast port, etc. The tunneling module 152 may also control a process of generating a second IP packet including header information and the data. In such an aspect, the header information may include only information indicating at least one of the IP version, the destination multicast address, or the destination multicast port. Still further, the tunneling module 152 may control a process of sending the second IP packet to the UE 103 based on the destination multicast address, the destination multicast port, etc.

The UE 103 includes a de-tunneling module 153. The de-tunneling module 153 may control a process of receiving an IP packet including header information and data for a MBMS session. In an aspect, the header information may include only information indicating at least one of an IP version, a destination multicast address of the IP packet, or a destination multicast port of the IP packet. The de-tunneling module 153 may also control a process of generating a multicast datagram including the data. In such an aspect, the multicast datagram may be generated based on at least one of the information indicating the destination multicast address or the information indicating the destination multicast port. Still further, the de-tunneling module 153 may control a process of sending the multicast datagram to an application running on the UE 103.

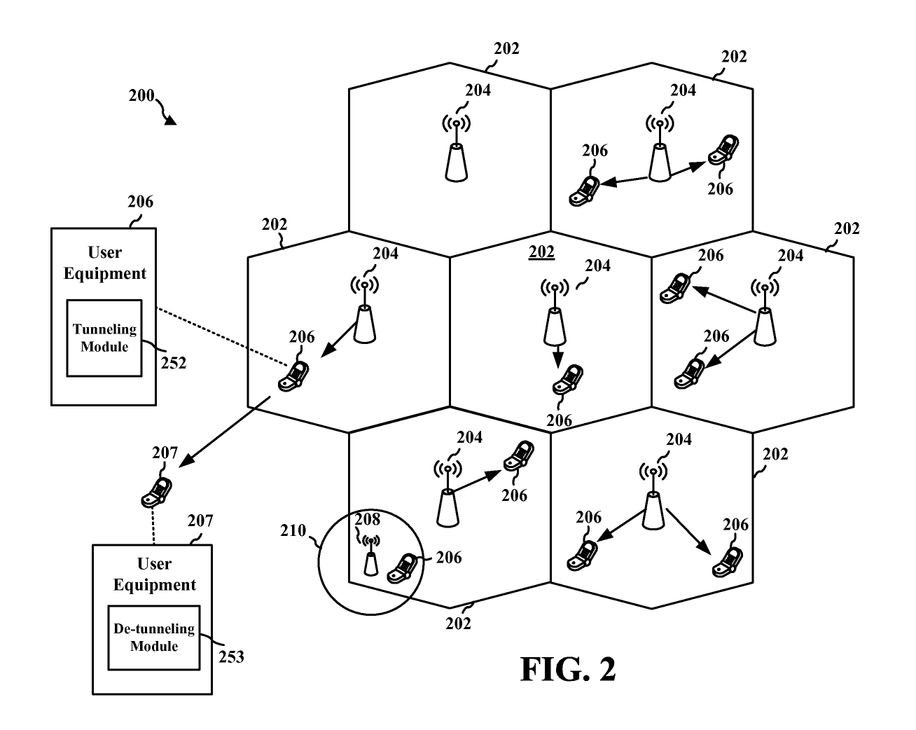

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sectors). The term “cell” can refer to the smallest coverage area of an eNB and/or an eNB subsystem serving a particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

In certain configurations, the UE 206 is in communication with a UE 207 in a local or private network. The UE 206 includes a tunneling module 252. The tunneling module 252 may control a process of receiving a first IP packet which can include IP header information and data from the eNB 204. The IP header information may include an IP version, a destination multicast address, a destination multicast port, etc. The tunneling module 252 may also control a process of generating a second IP packet including header information and the data. In such an aspect, the header information may include only information indicating at least one of the IP version, the destination multicast address, or the destination multicast port. Still further, the tunneling module 252 may control a process of sending the second IP packet to the UE 207 based on the destination multicast address, the destination multicast port, etc.

The UE 207 includes a de-tunneling module 253. The de-tunneling module 253 may control a process of receiving an IP packet including header information and data for a MBMS session. In an aspect, the header information may include only information indicating at least one of an IP version, a destination multicast address of the IP packet, or a destination multicast port of the IP packet. The de-tunneling module 253 may also control a process of generating a multicast datagram including the data. In such an aspect, the multicast datagram may be generated based on at least one of the information indicating the destination multicast address or the information indicating the destination multicast port. Still further, the de-tunneling module 253 may control a process of sending the multicast datagram to an application running on the UE 207.

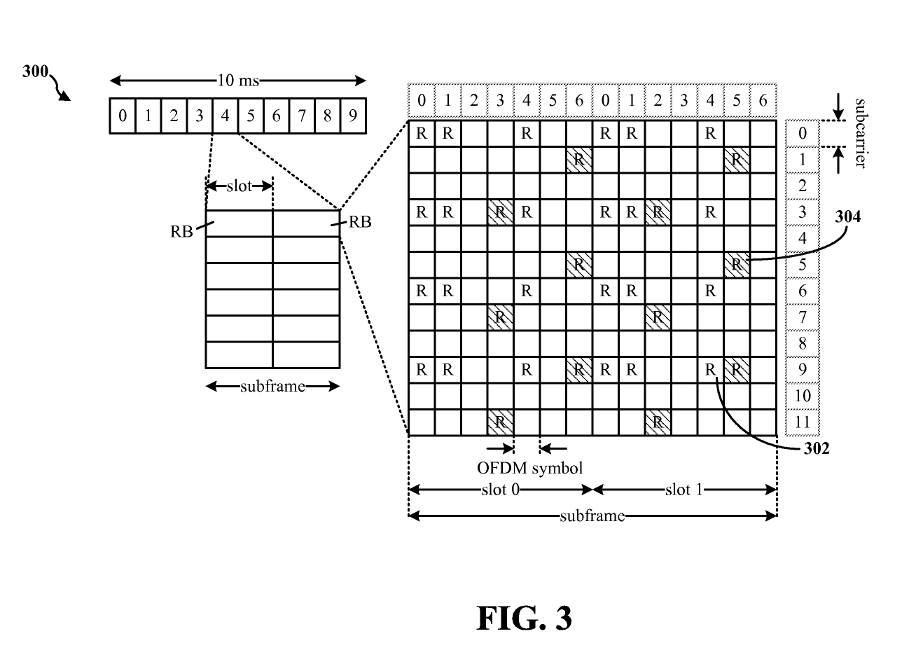

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

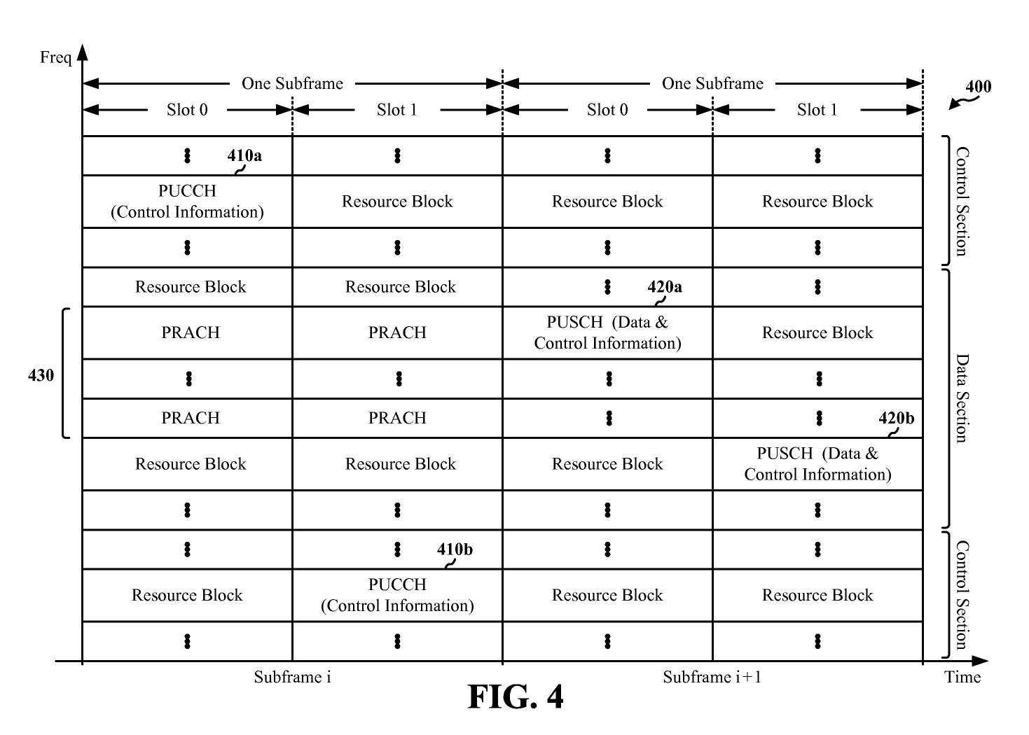

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make a single PRACH attempt per frame (10 ms).

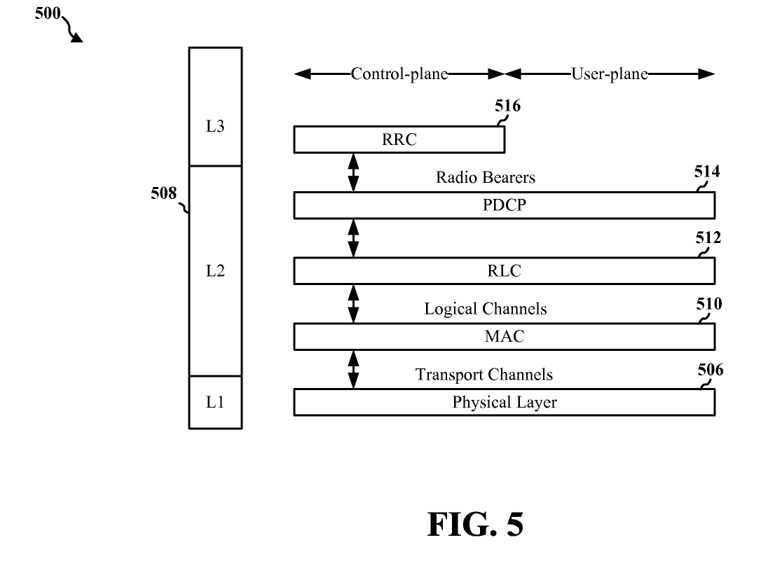

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

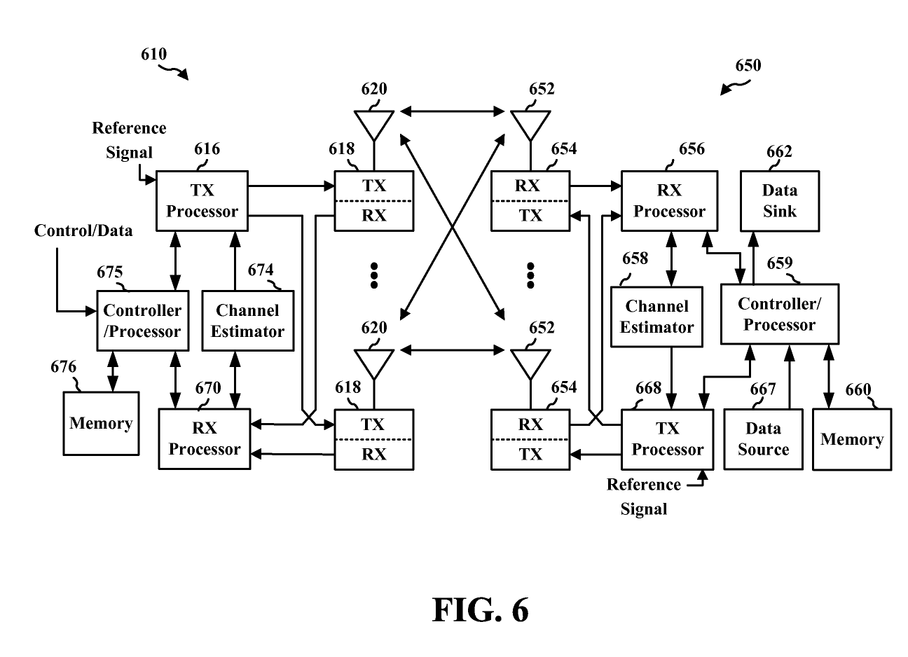

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

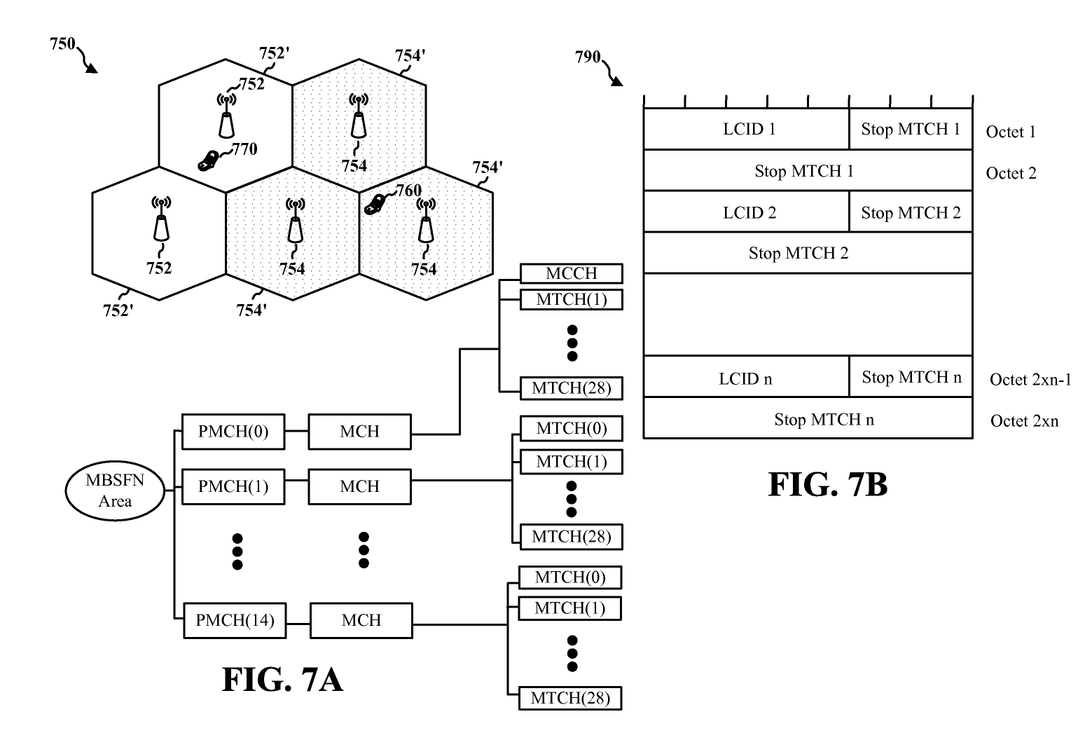

FIG. 7A is a diagram 750 illustrating an example of an evolved MBMS (eMBMS) channel configuration in an MBSFN. The eNBs 752 in cells 752′ may form a first MBSFN area and the eNBs 754 in cells 754′ may form a second MBSFN area. The eNBs 752, 754 may each be associated with other MBSFN areas, for example, up to a total of eight MBSFN areas. A cell within an MBSFN area may be designated a reserved cell. Reserved cells do not provide multicast/broadcast content, but are time-synchronized to the cells 752′, 754′ and may have restricted power on MBSFN resources in order to limit interference to the MBSFN areas. Each eNB in an MBSFN area synchronously transmits the same eMBMS control information and data. Each area may support broadcast, multicast, and unicast services. A unicast service is a service intended for a specific user, e.g., a voice call. A multicast service is a service that may be received by a group of users, e.g., a subscription video service. A broadcast service is a service that may be received by all users, e.g., a news broadcast. Referring to FIG. 7A, the first MBSFN area may support a first eMBMS broadcast service, such as by providing a particular news broadcast to UE 770. The second MBSFN area may support a second eMBMS broadcast service, such as by providing a different news broadcast to UE 760. Each MBSFN area supports one or more physical multicast channels (PMCH) (e.g., 15 PMCHs). Each PMCH corresponds to a multicast channel (MCH). Each MCH can multiplex a plurality (e.g., 29) of multicast logical channels. Each MBSFN area may have one multicast control channel (MCCH). As such, one MCH may multiplex one MCCH and a plurality of multicast traffic channels (MTCHs) and the remaining MCHs may multiplex a plurality of MTCHs.

A UE can camp on an LTE cell to discover the availability of eMBMS service access and a corresponding access stratum configuration. Initially, the UE may acquire a system information block (SIB) 13 (SIB13). Subsequently, based on the SIB13, the UE may acquire an MBSFN Area Configuration message on an MCCH. Subsequently, based on the MBSFN Area Configuration message, the UE may acquire an MCH scheduling information (MSI) MAC control element. The SIB13 may include (1) an MBSFN area identifier of each MBSFN area supported by the cell; (2) information for acquiring the MCCH such as an MCCH repetition period (e.g., 32, 64, . . . , 256 frames), an MCCH offset (e.g., 0, 1, . . . , 10 frames), an MCCH modification period (e.g., 512, 1024 frames), a signaling modulation and coding scheme (MCS), subframe allocation information indicating which subframes of the radio frame as indicated by repetition period and offset can transmit MCCH; and (3) an MCCH change notification configuration. There is one MBSFN Area Configuration message for each MBSFN area. The MBSFN Area Configuration message may indicate (1) a temporary mobile group identity (TMGI) and an optional session identifier of each MTCH identified by a logical channel identifier within the PMCH, and (2) allocated resources (i.e., radio frames and subframes) for transmitting each PMCH of the MBSFN area and the allocation period (e.g., 4, 8, . . . , 256 frames) of the allocated resources for all the PMCHs in the area, and (3) an MCH scheduling period (MSP) (e.g., 8, 16, 32, . . . , or 1024 radio frames) over which the MSI MAC control element is transmitted.

FIG. 7B is a diagram 790 illustrating the format of an MSI MAC control element. The MSI MAC control element may be sent once each MSP. The MSI MAC control element may be sent in the first subframe of each scheduling period of the PMCH. The MSI MAC control element can indicate the stop frame and subframe of each MTCH within the PMCH. There may be one MSI per PMCH per MBSFN area.

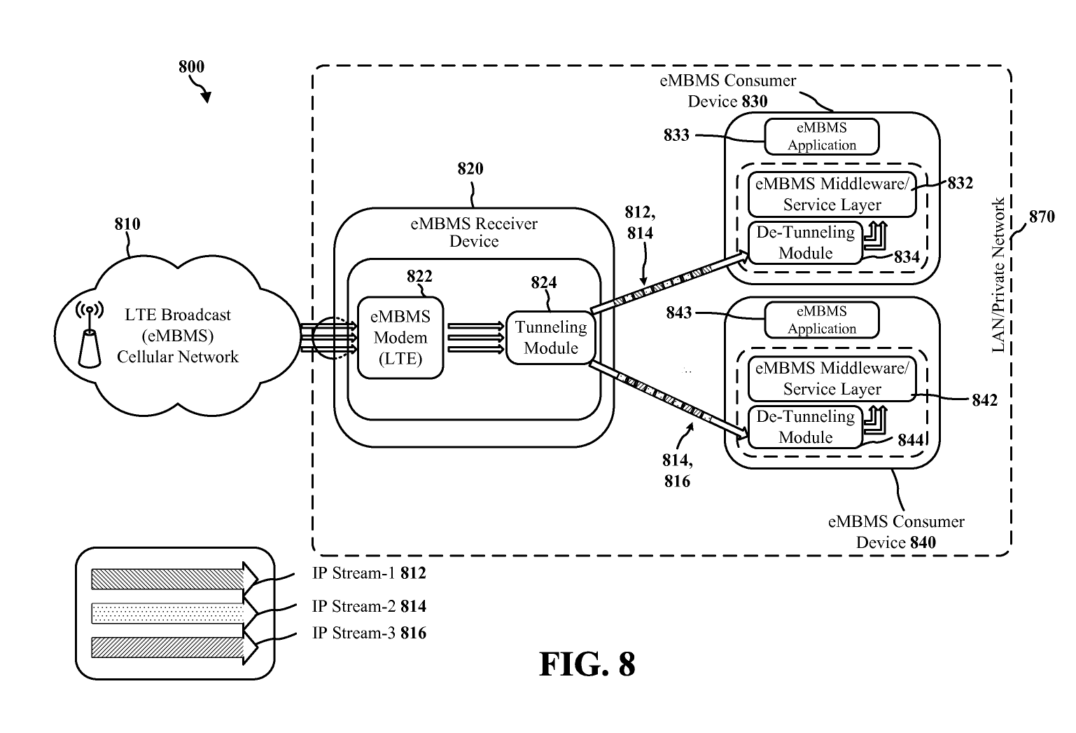

FIG. 8 is a diagram 800 illustrating an exemplary distributed eMBMS client architecture. In this configuration, an eMBMS receiver device 820 and one or more eMBMS consumer devices 830, 840 are in a local/private network 870. Lower layer eMBMS modules (e.g., an eMBMS modem 822) may be on the eMBMS receiver device 820. The eMBMS receiver device 820 receives eMBMS multicast services from a cellular/eMBMS network 810. For example, the eMBMS receiver device 820 may be an outdoor unit (ODU) or a UE 102 serving as soft access point (SoftAP). Higher layer eMBMS modules such as eMBMS middleware/service layer modules 832, 842 and user applications 833, 843 (i.e., eMBMS consumers) may run on eMBMS consumer devices 830, 840, respectively. Further, the eMBMS receiver device 820 includes a tunneling module 824. The eMBMS consumer devices 830, 840 include de-tunneling modules 834, 844, respectively.

In such a distributed architecture, the eMBMS receiver device 820 may be multi-homed, acting as a bridge between the cellular/eMBMS network 810 and the local/private network 870 with one or more nodes that are eMBMS consumer devices 830, 840. In other words, the eMBMS receiver device 820 is part of (home in) the cellular/eMBMS network 810 and is also part of (home in) the local/private network 870 (i.e., multi-homed). In operation, the eMBMS consumer devices 830, 840 (on the local/private network 870) may inform the eMBMS receiver device 820 of all eMBMS multicast services that the eMBMS consumer devices 830, 840 are interested in receiving by providing the eMBMS receiver device 820 with the appropriate destination IP multicast address and/or destination multicast port information as well as the associated Temporary Mobile Group Identifier (TMGI) associated with the interested eMBMS multicast services. TMGI is a globally unique identifier for a particular eMBMS layer bearer service that carries the specified eMBMS multicast service.

The eMBMS receiver device 820 monitors the eMBMS multicast services transmitted on the cellular/eMBMS network 810, and downloads the eMBMS multicast services (e.g., a multicast IP stream-1 812, a multicast IP stream-2 814, and a multicast IP stream-3 816) that are requested by one or more of the eMBMS consumer devices 830, 840 on the local/private network 870. The eMBMS receiver device 820 distributes the requested eMBMS multicast services to the interested eMBMS consumer devices 830, 840 on the local/private network 870. Particularly, the tunneling module 824 of the eMBMS receiver device 820 tunnels relevant eMBMS multicast datagrams to corresponding eMBMS consumer device 830/840. The de-tunneling modules 834, 844 on the eMBMS consumer device 830/840 process incoming tunneled packets and retransmit de-tunneled multicast packets locally (on device) for delivery to the eMBMS consumers on the eMBMS consumer device 830/840.

This distributed architecture allows the eMBMS consumers to function normally and receive eMBMS multicast data locally without regard to whether the eMBMS receiver is on the local device or a remote device.

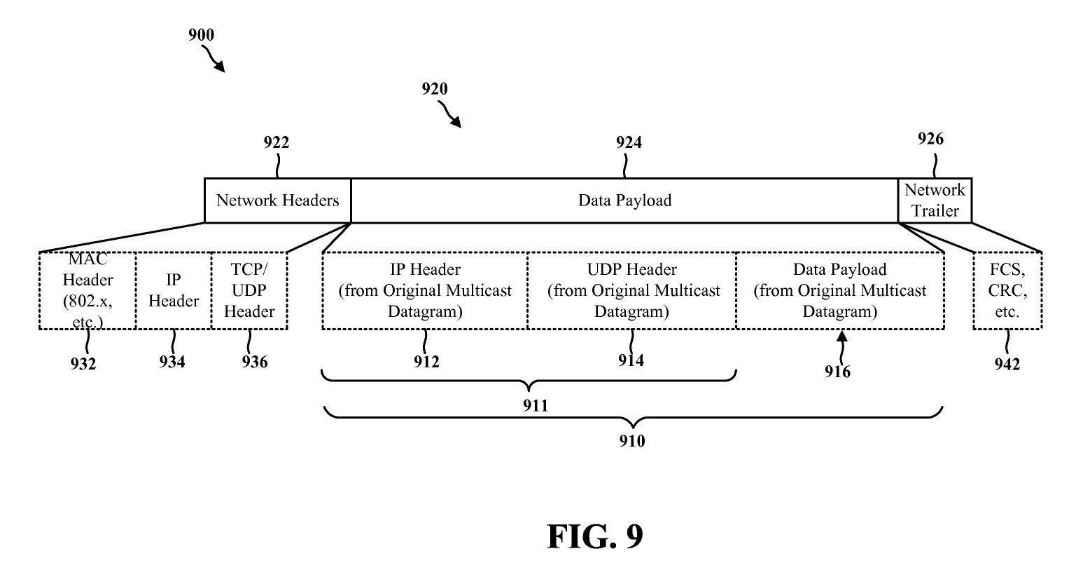

FIG. 9 is a diagram 900 illustrating one format of a tunneled packet in accordance with a technique for distributing eMBMS multicast services. In one configuration, the eMBMS modem 822 receives one or more eMBMS datagrams 910 of the interested eMBMS multicast services from the cellular/eMBMS network 810. For example, the eMBMS datagram 910 may be for the multicast IP stream-1 812, the multicast IP stream-2 814, or the multicast IP stream-3 816. The eMBMS datagram 910 may include a header section 911, which includes an IP header 912 and a UDP header 914. The IP header 912 may include a destination IP multicast address. The UDP header 914 may include a destination multicast port. The eMBMS datagram 910 also includes a multicast data payload 916. Subsequently, the eMBMS modem 822 may send the eMBMS datagrams 910 to the tunneling module 824.

The tunneling module 824, in accordance with a tunneling procedure, adds a tunnel network header 922 and a tunnel network trailer 926 to the received eMBMS datagram 910. The tunnel network header 922 may include a MAC header 932 (e.g., IEEE 802 header), an IP header 934, a TCP/UDP header 936, etc. The tunnel network trailer 926 may include frame check sequence (FCS) and/or cyclic redundancy check (CRC) information. By using this technique, the tunneling module 824 adds the tunnel network header 922 and the tunnel network trailer 926 to the un-manipulated (“raw”) eMBMS datagram 910 that is received from the cellular/eMBMS network 810 to construct a new tunneled packet 920. As a result of this technique, the eMBMS datagram 910 includes a tunnel data payload 924 of the tunneled packet 920.

If the eMBMS datagram 910 has been fragmented in the cellular/eMBMS network 810, the tunneling module 824 may fully reassemble the fragmented eMBMS datagram 910 and then transmits the un-fragmented eMBMS datagram 910 to the eMBMS consumer devices 830, 840.

The de-tunneling modules 834, 844 on the eMBMS consumer device 830/840 may be able to apply raw eMBMS datagrams 910, in its entirety, to the local IP stack without having to parse and/or process the eMBMS datagrams 910. This technique may reduce the likelihood of bottlenecks in the de-tunneling module 834/844.

In certain circumstances, using raw eMBMS datagrams 910 may introduce inefficiencies during de-tunneling on certain runtime environments, for example, when dealing with bursty network traffic and processing at a rate of hundreds of packets per second. Particularly, on many platforms, the de-tunneling module 834/844 cannot run with escalated privileges to inject raw multicast packets (i.e., eMBMS datagram 910) in to the local IP stack for retransmission. Root/admin privilege may be used to apply raw IP packets into the IP stack. The de-tunneling module 834/844, therefore, may process the tunnel data payload 924 of each tunneled packet 920 to remove the included IP and UDP headers from the raw multicast packet, and extract the destination IP multicast address and/or destination multicast port from these headers. The de-tunneling module 834/844 may also extract the multicast data payload 916 from the tunnel data payload 924. Subsequently, the de-tunneling module 834/844 may construct a new multicast datagram using the destination IP multicast address, destination multicast port, and the multicast data payload 916, and then re-transmits the multicast datagram on the local device using the normal UDP/IP delivery mechanisms. In other words, in order to remove the destination IP multicast address and the destination multicast port, the de-tunneling module 834/844 may need to process the entire IP header 912 and the UDP header 914. This additional overhead of parsing the IP and UDP headers from the raw IP packets may increase the processing burden on the de-tunneling module 834/844 and may affect the overall throughput capability of the de-tunneling module 834/844, especially when processing Internet protocol version 6 (IPv6) headers which can have a chain of several optional IP header extensions that have to be parsed and stripped individually.

Additionally, tunneling the eMBMS datagram 910 in its entirety (i.e., as raw UDP/IP multicast packets with the original IP and UDP headers) adds extra bytes to the tunneled packet 920. Internet protocol version 4 (IPv4) has 20 plus 8 bytes fixed headers. IPv6 has minimum 40 plus 8 bytes fixed headers, and even larger total header size if one or more of the optional IP header extensions are included. Most fields in the original IP and UDP headers are not needed by the de-tunneling module 834/844. Thus, including these headers in the tunneled packet 920 decreases tunneling/network throughput capacity as well as increases memory consumption for the receive buffers that hold unprocessed tunneled packets on the eMBMS consumer devices 830, 840.

When de-tunneling on resource constrained devices, the combined effect of the above issues may result in wasteful CPU usage, battery/power consumption, memory consumption, etc.

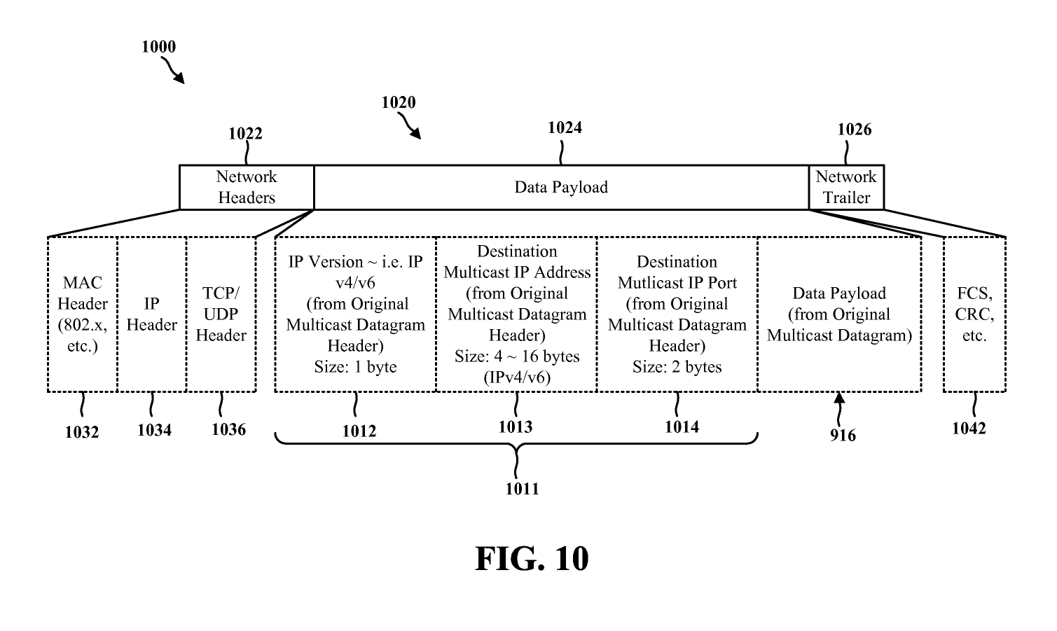

FIG. 10 is a diagram 1000 illustrating another format of a tunneled packet in accordance with a technique for distributing eMBMS multicast services. A tunneled packet 1020 in accordance with this format includes a tunnel network header 1022, a tunnel data payload 1024, and a tunnel network trailer 1026. The tunnel data payload 1024 has a data structure that is in accordance with a predefined data structure definition. In this configuration, the associated data structure definition defines that the tunnel data payload 1024 has a header section 1011 and a multicast data payload 916. The associated data structure definition further defines that the header section 1011 includes an IP version section 1012, a destination IP multicast address section 1013, and a destination multicast port section 1014, as well as the order of the sections. The IP version section 1012 may be the first section and may include one byte to indicate the IP version of the destination IP multicast address. The destination IP multicast address section 1013 may be the second section, and may include four bytes to indicate an IPv4 destination IP multicast address or 16 bytes to indicate an IPv6 destination IP multicast address. The destination multicast port section 1014 may be the third section and may include two bytes to indicate the destination multicast port.

In operation, the eMBMS modem 822 may receive one or more eMBMS datagrams 910 of the interested eMBMS multicast services from the cellular/eMBMS network 810. Each of the eMBMS multicast services has associated destination IP multicast address and destination multicast port. The eMBMS modem 822 sends eMBMS datagrams 910 of a particular eMBMS multicast service to a socket (identified by the destination IP multicast address and the destination multicast port) of network interface that is used by the tunneling module 824. The tunneling module 824 receives the particular eMBMS multicast service through the socket. As will be described infra, the tunneling module 824 constructs the tunneled packet 1020 in accordance with the associated definition.

Initially, the eMBMS receiver device 820 and the eMBMS consumer devices 830, 840 communicate with each other to agree on an associated data structure definition to be used in a tunneling procedure. Subsequently, after receiving an eMBMS datagram 910 from the eMBMS modem 822 at a particular socket for the first time and optionally at other times, the tunneling module 824 processes (e.g., parses) the IP header 912 and the UDP header 914 to extract the destination IP multicast address and the destination multicast port. The tunneling module 824 can detect the IP version (e.g., IPv4 or IPv6) of the eMBMS datagram 910. Additionally or in the Alternative, because the tunneling module 824 has knowledge regarding the socket, which is associated with a particular destination IP multicast address and destination multicast port combination, the tunneling module 824 can infer or obtain the destination IP multicast address and the destination multicast port from the particular socket used. The tunneling module 824 then constructs a header section in accordance with the associated data structure definition.

In the example shown in FIG. 10, the tunneling module 824 determines, based on the processed data, the IP version of the destination IP multicast address. The tunneling module 824 constructs an IP version section 1012 in accordance with the associated data structure definition, using the allocated bytes to indicate the determined IP version. The tunneling module 824 further constructs the destination IP multicast address section 1013 in accordance with the associated data structure definition, using the allocated bytes to indicate the destination IP multicast address. For example, the tunneling module 824 may use four bytes to indicate an IPv4 destination IP multicast address and may use 16 bytes to indicate an IPv6 destination IP multicast address. The tunneling module 824 further constructs the destination multicast port section 1014 in accordance with the associated data structure definition, using the allocated bytes to indicate the destination multicast port. For example, the tunneling module 824 may use two bytes to indicate the destination multicast port. The tunneling module 824 constructs the header section 1011 including the IP version section 1012, the destination IP multicast address section 1013, and the destination multicast port section 1014 in an order in accordance with the associated data structure definition. The tunnel data payload 1024 includes the header section 1011 and the multicast data payload 916.

The tunneling module 824 processes the eMBMS datagram 910 to extract the multicast data payload 916. The tunneling module 824, in accordance with a tunneling procedure, constructs a tunneled packet 1020. The tunneled packet 1020 includes a tunnel network header 1022, the header section 1011, the multicast data payload 916, and a tunnel network trailer 1026. The tunnel network header 1022 may include a MAC header 1032 (e.g., IEEE 802 header), an IP header 1034, and a TCP/UDP header 1036, which are used to indicate the network address of an eMBMS consumer device 830/840 to which the tunneled packet 1020 is directed. The tunnel network trailer 1026 may include frame check sequence (FCS) and/or cyclic redundancy check (CRC) information. The tunneling module 824 then transmits the tunneled packet 1020 to the eMBMS consumer devices 830, 840 that subscribed the eMBMS multicast service associated with the eMBMS datagram 910.

The tunneling module 824 may cache (e.g., in a memory or a storage) the constructed header section 1011. Subsequently, when the tunneling module 824 receives another eMBMS datagram 910 at the particular socket, the tunneling module 824 may process the eMBMS datagram 910 to extract the multicast data payload 916, and then may use the cached constructed header section 1011 and the extracted multicast data payload 916 to construct the tunnel data payload 1024. The tunneling module 824 also adds the tunnel network header 1022 and the tunnel network trailer 1026 to construct another tunneled packet 1020 to be transmitted to the eMBMS consumer devices 830, 840.

The de-tunneling module 834/844 receives a tunneled packet 1020 from the tunneling module 824 through a socket of a network interface at the eMBMS consumer device 830/840. In this example, the socket can processes the tunneled packet 1020 and can obtain the tunnel data payload 1024. The de-tunneling module 834/844 may obtain the tunnel data payload 1024 from the socket. The de-tunneling module 834/844 knows the associated data structure definition in accordance with which the tunneled packet 1020 was constructed, and processes the tunnel data payload 1024 using the associated data structure definition. The de-tunneling module 834/844 locates the IP version section 1012 from the tunnel data payload 1024 and then processes the data to determine the IP version of the destination IP multicast address. For example, the de-tunneling module 834/844 may determine that 0 indicates IPv4 and 1 indicates IPv6. Based on the IP version, the de-tunneling module 834/844 can determine the size of the destination IP multicast address section 1013 in accordance with the associated data structure definition. For example, when the IP version is IPv4, the de-tunneling module 834/844 can locate the next four bytes based on the associated data structure definition. When the IP version is IPv6, the module can locate the next 16 bytes based on the data structure definition. Once located the destination IP multicast address section 1013, the module can process the data to determine the destination IP multicast address. The module then locates the destination multicast port section 1014 based on the data structure definition. In this example, the de-tunneling module 834/844 locates the next two bytes and processes the data to determine the destination multicast port. The de-tunneling module 834/844 can also determine that the remaining data of the tunnel data payload 1024 are the multicast data payload 916.

Subsequently, the de-tunneling module 834/844 can construct a new multicast datagram based on the destination IP multicast address, destination multicast port, and the multicast data payload 916. The de-tunneling module 834/844 further sends the multicast datagram to a network interface (e.g., a local “loopback” network interface) that is used or monitored by the user application 833/843. Therefore, the user application 833/843 can receive the multicast datagrams constructed by the de-tunneling module 834/844 for the eMBMS multicast services that the user applications have subscribed.

In this technique, at the beginning of the tunneled packet, the eMBMS receiver device 820 may include one byte indicating the IP version (to determine if address is IPv4 or IPv6) followed by the destination IP multicast address plus destination multicast port and then the original multicast data payload 916. Using this technique may not incur any extra processing on the tunneling module 824, because combination of the IP version, the destination IP multicast address, and the destination multicast port is invariant in a particular eMBMS service session and can be easily cached. Using this technique may eliminate some IP header processing (irrespective of IPv4 or IPv6 headers) in the de-tunneling module 834/844. The de-tunneling module 834/844 may efficiently access the included destination IP multicast address and destination multicast port information bytes from the tunneled packet 1020 and retransmit the multicast data payload 916. This technique may reduce processing overhead, save battery and other resources, which may result in less delay in packet delivery to user applications.

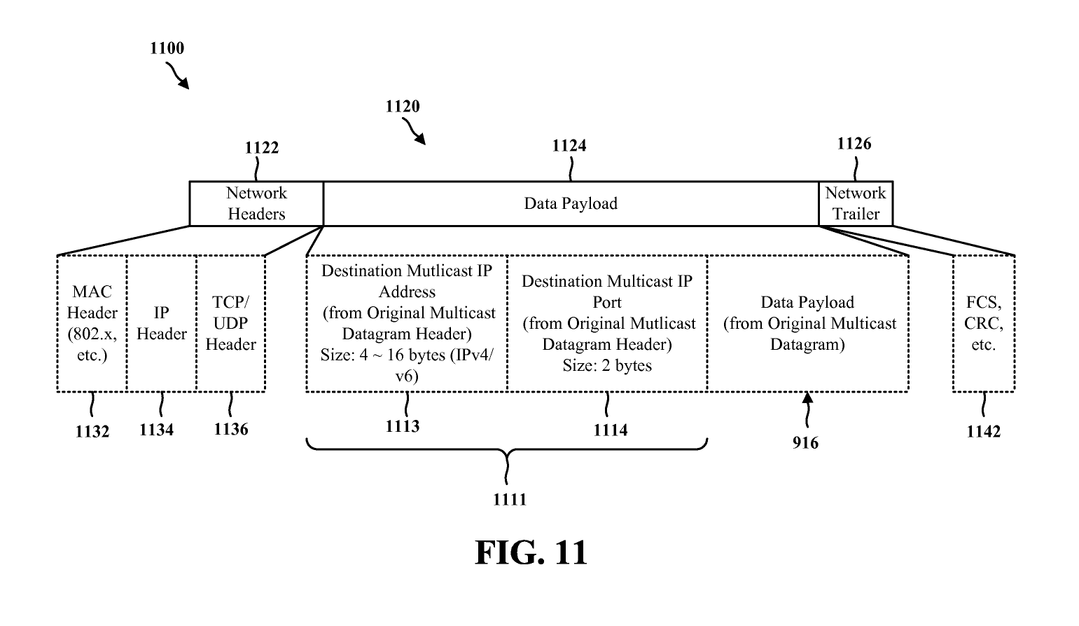

FIG. 11 is a diagram 1100 illustrating another format of a tunneled packet in accordance with a technique for distributing eMBMS multicast services. A tunneled packet 1120 in accordance with this format includes a tunnel network header 1122, a tunnel data payload 1124, and a tunnel network trailer 1126. The tunnel data payload 1124 has a data structure that is in accordance with another predefined data structure definition. In this configuration, the associated data structure definition defines that the tunnel data payload 1124 has a header section 1111 and a multicast data payload 916. The associated data structure definition further defines that the header section 1111 includes a destination IP multicast address section 1113 and a destination multicast port section 1114, as well as the order of the sections.

The tunnel network header 1122, the tunnel network trailer 1126, the destination IP multicast address section 1113, the destination multicast port section 1114, and the multicast data payload 916 are similar to those described supra with reference to FIG. 10. In one configuration, comparing to the header section 1011, the header section 1111 does not have a section that corresponds to IP version section 1012. The destination IP multicast address section 1113 may be the first section of the header section 1111, and may include four bytes to indicate an IPv4 destination IP multicast address or 16 bytes to indicate an IPv6 destination IP multicast address. The destination multicast port section 1114 may be the second section and may include two bytes to indicate the destination multicast port. In another configuration, comparing to the header section 1011, the header section 1111 further does not have a section that corresponds to destination IP multicast address section 1013. The destination multicast port section 1114 may be the first section and may include two bytes to indicate the destination multicast port.

In these configurations, during initialization and subsequent communication, the tunneling module 824 can learn the IP version of the destination IP multicast addresses used by the cellular/eMBMS network 810. For example, an eMBMS multicast service carrier can broadcast an announcement through the cellular/eMBMS network 810 to announce that the IP version of some or all destination IP multicast addresses used in the cellular/eMBMS network 810.

The eMBMS middleware/service layer module 832 can determine that all eMBMS multicast services subscribed by a particular eMBMS consumer device 830/840 use the same IP version for destination IP multicast addresses. For example, the subscribed eMBMS multicast services may be all from the same eMBMS multicast service carrier or the same eMBMS multicast service network. Accordingly, the eMBMS middleware/service layer module 832 or the de-tunneling module 834/844 can inform the tunneling module 824 that all destination IP multicast addresses will have the same IP version. The tunneling module 824 and the de-tunneling module 834/844 accordingly select a data structure definition associated with that IP version. The data structure definition indicates that the header section 1111 only includes the destination IP multicast address section 1113 and the destination multicast port section 1114 (i.e., no IP version section). Similar to the operations described supra with reference to FIG. 10, the de-tunneling module 834/844 can locate the destination IP multicast address section 1113 (e.g., four bytes for IPv4 or 16 bytes for IPv6) and the destination multicast port section 1114 (e.g., two bytes). Accordingly, the de-tunneling module 834/844 can determine the destination IP multicast address and the destination multicast port. Subsequently, the de-tunneling module 834/844 can construct a multicast datagram with the destination IP multicast address, the destination multicast port, and the multicast data payload 916, using the operations described supra with reference to FIG. 10.

Further, in one configuration, the eMBMS multicast service carrier may inform the de-tunneling module 834/844 and/or the eMBMS middleware/service layer module 832 that some or all of the eMBMS multicast services use the same destination IP multicast address (with different destination multicast ports). Accordingly, the eMBMS middleware/service layer module 832 or the de-tunneling module 834/844 can inform the tunneling module 824 that all multicast datagrams will have the same destination IP multicast address. The tunneling module 824 and the de-tunneling module 834/844 accordingly select an associated data structure definition, which indicates that the header section 1111 only includes the destination multicast port section 1114 (i.e., no IP version section and no destination IP multicast address section 1113). Similar to the operations described supra with reference to FIG. 10, the de-tunneling module 834/844 can locate the destination multicast port section 1114 (e.g., two bytes). Accordingly, the de-tunneling module 834/844 can determine the destination multicast port. Subsequently, the de-tunneling module 834/844 can construct a multicast datagram with the destination IP multicast address previously determined by the de-tunneling module 834/844, the destination multicast port, and the multicast data payload 916 using the operations described supra with reference to FIG. 10.

Further, in one configuration, the eMBMS multicast service carrier may inform the de-tunneling module 834/844 and/or the eMBMS middleware/service layer module 832 that some or all of the eMBMS multicast services use the same destination multicast port (with different destination IP multicast addresses). Accordingly, the eMBMS middleware/service layer module 832 or the de-tunneling module 834/844 can inform the tunneling module 824 that all multicast datagrams will have the same destination multicast port.

In one configuration, as described supra, the eMBMS middleware/service layer module 832 can determine that all eMBMS multicast services subscribed by a particular eMBMS consumer device 830/840 use the same IP version. Thus, the de-tunneling module 834/844 knows the IP version to be used for de-tunneling the eMBMS multicast services. Accordingly, the eMBMS middleware/service layer module 832 or the de-tunneling module 834/844 can inform the tunneling module 824 that all multicast datagrams will have the same IP version.

The tunneling module 824 and the de-tunneling module 834/844 accordingly select an associated data structure definition, which indicates that the header section 1111 only includes the destination IP multicast address section 1113 or indicates that the header section 1111 only includes the destination IP multicast address section 1113 and an IP version section (i.e., no destination multicast port section 1114). Similar to the operations described supra with reference to FIG. 10, the de-tunneling module 834/844 can locate the destination IP multicast address section 1113 (e.g., four bytes for IPv4 or 16 bytes for IPv6). Accordingly, the de-tunneling module 834/844 can determine the destination IP multicast address. Subsequently, the de-tunneling module 834/844 can construct a multicast datagram with the destination IP multicast address, the destination multicast port previously determined by the de-tunneling module 834/844, and the multicast data payload 916 using the operations described supra with reference to FIG. 10.

In certain aspects, this technique is similar to the technique described supra with reference to FIG. 10. The original Multicast IP and UDP headers are not included in the tunneled packet. Further, in one configuration, the beginning of the tunneled packet only has the destination IP multicast address plus the destination multicast port followed by the original multicast data payload 916. The one byte for indicating the IP version in accordance with the technique described supra with reference to FIG. 10 is not included in the tunneled packet. The tunneling module 824 and the de-tunneling module 834/844 can determine at runtime (e.g., via certain configuration and service announcement data) that the destination IP multicast addresses will always be either IPv4 or IPv6 for the given eMBMS network. Based on this knowledge, the de-tunneling module 834/844 can interpret the destination IP multicast address in the tunneled packet accordingly (i.e., always as IPv4 or IPv6) for all tunneled packets. This technique can eliminate the need for including one byte for the IP version at the beginning of a tunneled packet.

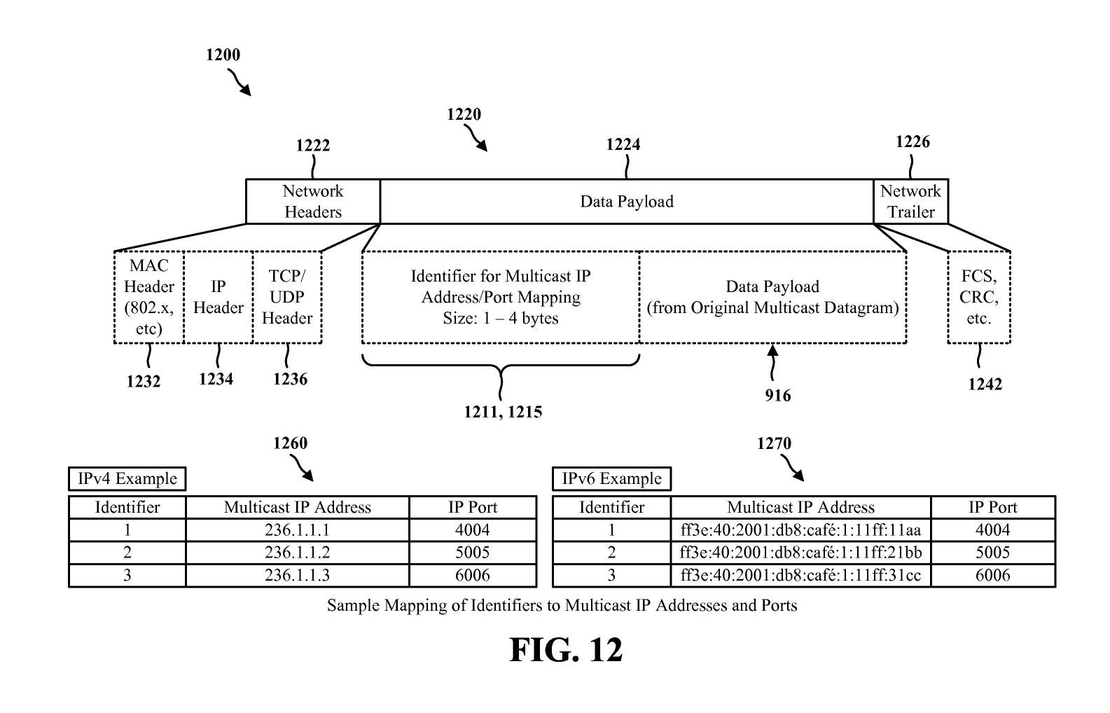

FIG. 12 is a diagram 1200 illustrating another format of a tunneled packet in accordance with a technique for distributing eMBMS multicast services. A tunneled packet 1220 in accordance with this format includes a tunnel network header 1222, a tunnel data payload 1224, and a tunnel network trailer 1226. The tunnel data payload 1224 has a data structure that is in accordance with another predefined data structure definition. In this configuration, the associated data structure definition defines that the tunnel data payload 1224 has a header section 1211 and a multicast data payload 916. The associated data structure definition further defines that the header section 1211 includes an identifier section 1215.

The tunneling module 824 and the de-tunneling module 834/844 can communicate with each other and each obtain at least one of mapping table 1260, 1270 (or other data structures) that each map a set of the identifiers with a set of addresses-and-port combinations. The mapping table 1260, 1270 can be an IPv4 mapping table 1260 or an IPv6 mapping table 1270. Each identifier in the IPv4 mapping table 1260 can identify one IPv4 destination IP multicast address and one destination multicast port. Each identifier in the IPv6 mapping table 1270 can identify one IPv6 destination IP multicast address and one destination multicast port. The mapping table 1260, 1270 can be generated at the tunneling module 824, the de-tunneling module 834/844, or an independent server in the network. Copies of one or more of the mapping table 1260, 1270 are sent to the tunneling module 824 and the de-tunneling module 834/844. Additionally or in the alternative, the mapping table 1260, 1270 may be independently generated at each of the tunneling module 824 and the de-tunneling module 834/844 using the same algorithm, which ensures the entries in the mapping table 1260, 1270 at the tunneling module 824 and the de-tunneling module 834/844 are identical.

The de-tunneling module 834/844 is informed of the data structure definition associated with the identifiers and use the operations described supra with reference FIG. 10 to process the packet in accordance with the associated definition. More specifically, the de-tunneling module 834/844 locates the identifier section 1215 section and processes the data to determine the identifier. After obtaining the identifier, the de-tunneling module 834/844 uses the identifier to locate the destination IP multicast address and the destination multicast port from the mapping table 1260, 1270. Thus, the de-tunneling module 834/844 can determine the destination IP multicast address and the destination multicast port of the eMBMS datagram 910. Subsequently, the de-tunneling module 834/844 can construct a multicast datagram with the destination IP multicast address, the destination multicast port, and the multicast data payload 916, using the operations described supra with reference to FIG. 10.

Further, in a configuration, the eMBMS multicast service carrier may inform the de-tunneling module 834/844 and/or the eMBMS middleware/service layer module 832 that some or all of the eMBMS multicast services use the same destination IP multicast address (with different destination multicast ports). Accordingly, the eMBMS middleware/service layer module 832 or the de-tunneling module 834/844 can inform the tunneling module 824 that all multicast datagrams will have the same destination IP multicast address. The identifier section 1215 may only include information indicating the destination multicast port. The mapping table 1260, 1270 thus do not include destination IP multicast addresses and each identifier in the mapping table 1260, 1270 is mapped to a destination multicast port. The de-tunneling module 834/844 uses the identifier to locate the destination multicast port from the mapping table 1260, 1270. The de-tunneling module 834/844 can construct a multicast datagram with the destination IP multicast address previously determined by the de-tunneling module 834/844, the destination multicast port mapped with the identifier in the mapping table 1260, 1270, and the multicast data payload 916 using the operations described supra with reference to FIG. 10.

This technique may allow for the replacement of the IP version section 1012, the destination IP multicast address section 1013, and the destination multicast port section 1014 used in the technique discussed supra with reference to FIG. 10 with an identifier section 1215. The tunneling module 824 and the de-tunneling module 834/844 maintain internal mapping of identifiers to IP version plus destination IP multicast address plus destination multicast port. The mapping table can be constructed and synchronized on both sides by either sending identifiers as part of multicast request from eMBMS consumer to receiver at the start of each session. For example, one-byte identifiers can be used. The identifiers can also be auto computed by using a common hash algorithm on both sides. Four-byte identifiers can be used. The hash value can be derived from the destination IP multicast address and the destination multicast port or the TMGI or a combination of all of them.

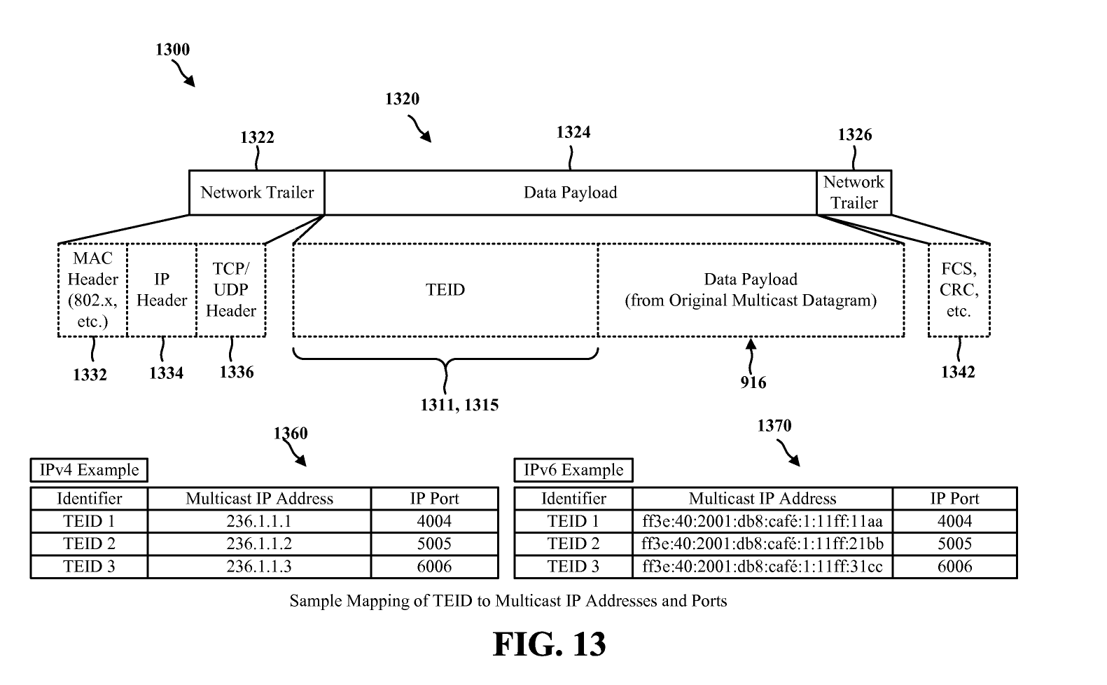

FIG. 13 is a diagram 1300 illustrating another format of a tunneled packet in accordance with a technique for distributing eMBMS multicast services. A tunneled packet 1320 is similar to the tunneled packet 1220. A tunneled packet 1320 in accordance with this format includes a tunnel network header 1322, a tunnel data payload 1324, and a tunnel network trailer 1326. The tunnel data payload 1324 has a data structure that is in accordance with another predefined data structure definition. In this configuration, the associated data structure definition defines that the tunnel data payload 1324 has a header section 1311 and a multicast data payload 916. The associated data structure definition further defines that the header section 1311 includes an identifier section 1315. The tunneled packet 1320 differs from the tunneled packet 1220 in that the header section 1311 contains a tunnel endpoint identifier (TEID) based on a general packet radio service (GPRS) tunneling protocol. For example, the header section 1311 may have eight bytes representing the GPRS header, of which four bytes represent the TEID.

Similar to the technique described supra with respect to FIG. 12, the tunneling module 824 and the de-tunneling module 834/844 in this technique each obtain mapping tables 1360, 1370. In the IPv4 mapping table 1360, each identifier is mapped with an IPv4 destination IP multicast address and a destination multicast port. In the IPv6 mapping table 1370, each identifier is mapped with an IPv6 destination IP multicast address and a destination multicast port.

The de-tunneling module 834/844 is informed of the data structure definition associated with the TEIDs and use the operations described supra with reference FIG. 10 to process the packet in accordance with the associated definition. More specifically, the de-tunneling module 834/844 locates the identifier section 1315 section and processes the data to determine the TEID. After obtaining the TEID, the de-tunneling module 834/844 uses the TEID to locate the destination IP multicast address and the destination multicast port from the mapping table 1360, 1370. Thus, the de-tunneling module 834/844 can determine the destination IP multicast address and the destination multicast port of the eMBMS datagram 910. Subsequently, the de-tunneling module 834/844 can construct a multicast datagram with the destination IP multicast address, the destination multicast port, and the multicast data payload 916, using the operations described supra with reference to FIG. 10.

Further, in a configuration, the eMBMS multicast service carrier may inform the de-tunneling module 834/844 and/or the eMBMS middleware/service layer module 832 that some or all of the eMBMS multicast services use the same destination IP multicast address (with different destination multicast ports). Accordingly, the eMBMS middleware/service layer module 832 or the de-tunneling module 834/844 can inform the tunneling module 824 that all multicast datagrams will have the same destination IP multicast address. The mapping tables 1360, 1370 thus do not include destination IP multicast addresses and each TEID in the mapping tables 1360, 1370 is mapped to a destination multicast port. The de-tunneling module 834/844 can construct a multicast datagram with the destination IP multicast address previously determined by the de-tunneling module 834/844, the destination multicast port mapped with the TEID in the mapping tables 1360, 1370, and the multicast data payload 916 using the operations described supra with reference to FIG. 10.

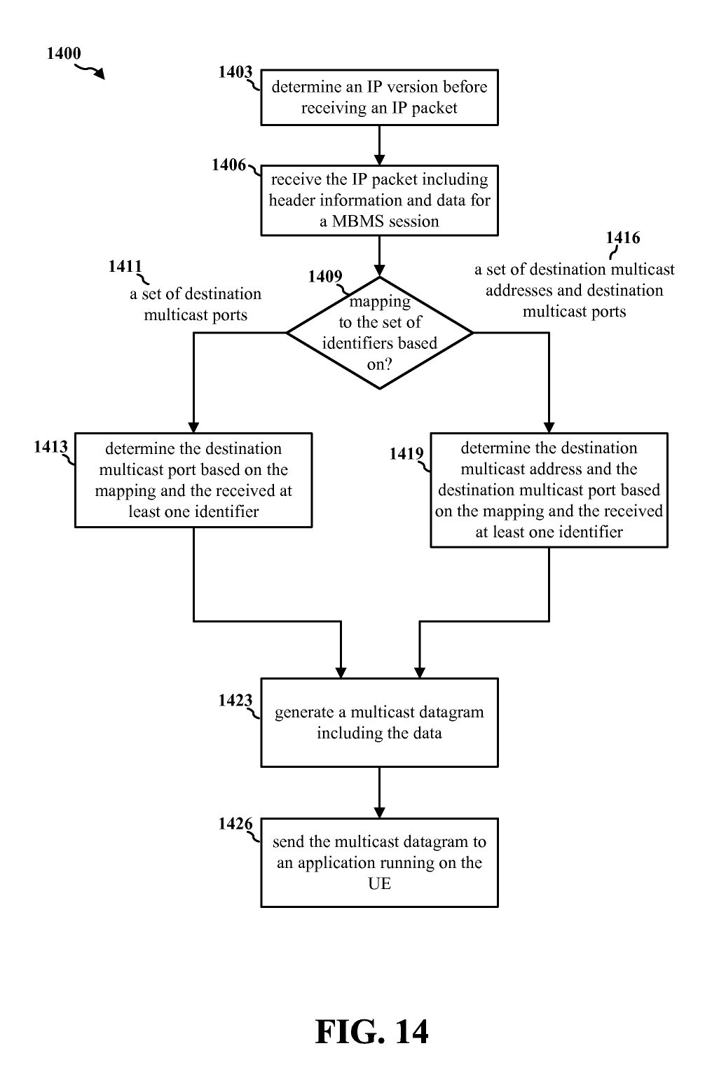

FIG. 14 is a flow chart 1400 of a method of wireless communication. The method may be performed by a UE (e.g., the eMBMS consumer devices 830, 840, the apparatus 1602/1602′). In certain configurations, at operation 1403, the UE determines an IP version before receiving an IP packet. For example, referring to FIG. 11, during initialization and subsequent communication, the tunneling module 824 can learn the IP version of the destination IP multicast addresses used by the cellular/eMBMS network 810. For example, an eMBMS multicast service carrier can broadcast an announcement through the cellular/eMBMS network 810 to announce that the IP version of some or all destination IP multicast addresses used in the cellular/eMBMS network 810. Thus, the de-tunneling module 834/844 can learn the IP version.

At operation 1406, the UE receives the IP packet including header information and data for an MBMS session. The header information includes only information indicating at least one of an IP version, a destination multicast address of the IP packet, or a destination multicast port of the IP packet. For example, referring to FIG. 8, the eMBMS consumer device 830/840 receives the tunneled packet 1020, the tunneled packet 1120, the tunneled packet 1220, or the tunneled packet 1320 from the eMBMS receiver device 820.

In certain configurations, the header information includes the IP version, the destination multicast address, and the destination multicast port. For example, referring to FIG. 10, the header section 1011 of the tunneled packet 1020 may only include the IP version, the destination multicast address, and the destination multicast port.

In another configuration, the header information includes only the destination multicast port. For example, referring to FIG. 12, the identifier section 1215 of the tunneled packet 1220 may only include information indicating the destination multicast port.

In still another configuration, the header information includes only the destination multicast address and the destination multicast port. For example, referring to FIG. 12, the identifier section 1215 of the tunneled packet 1220 may only include information indicating the destination multicast address and the destination multicast port.

In certain configurations, the IP version, the destination multicast address, the destination multicast port is invariant for the MBMS session.

In certain configurations, the information indicating the at least one of an IP version, a destination multicast address of the IP packet, or a destination multicast port of the IP packet is at least one identifier. The at least one identifier is a subset of a set of identifiers. In certain configurations, the at least one identifier is a TEID based on a GPRS tunneling protocol. For example, referring to FIG. 13, the identifier section 1315 of the tunneled packet 1320 includes TEID.

In certain configurations, subsequent to the operation 1406, the UE determines, at operation 1409, what information is provided upon which a mapping to the set of identifiers may be based. In an aspect, the determination may be based on a set of destination multicast ports (1411). In such an aspect, at operation 1413, the UE determines the destination multicast port based on the mapping and the received at least one identifier. For example, referring to FIG. 12, each identifier in the mapping table 1260, 1270 is mapped to a destination multicast port. The de-tunneling module 834/844 uses the identifier to locate the destination multicast port from the mapping table 1260, 1270.

In another aspect, at operation 1409, it may be determined (1416) that the at least one identifier is associated with both the destination multicast address and the destination multicast port. In such a configuration, subsequent to the operation 1406, the UE, at operation 1419, the UE determines the destination multicast address and the destination multicast port based on the mapping and the received at least one identifier. For example, referring to FIG. 12, after obtaining the identifier, the de-tunneling module 834/844 uses the identifier to locate the destination IP multicast address and the destination multicast port from the mapping table 1260, 1270.

In certain configurations, the at least one identifier is further associated with the IP version. The mapping is determined from a set of destination multicast addresses, destination multicast ports, and IP versions to the set of identifiers. The IP version is determined based on the mapping and the received at least one identifier.

At operation 1423, the UE generates a multicast datagram including the data. The multicast datagram is generated based on at least one of the information indicating the destination multicast address or the information indicating the destination multicast port. At operation 1426, the UE sends the multicast datagram to an application running on the UE. In certain configurations, the multicast datagram is sent to the application by locally broadcasting the received data on the destination multicast address and destination multicast port of the IP packet, and the application receives the data by opening a multicast IP socket to listen to the destination multicast address and destination multicast port. For example, referring to FIG. 10, the de-tunneling module 834/844 can construct a new multicast datagram based on the destination IP multicast address, destination multicast port, and the multicast data payload 916. The de-tunneling module 834/844 further sends the multicast datagram to a network interface (e.g., a local “loopback” network interface) that is used or monitored by the user application 833/843. Therefore, the user application 833/843 can receive the multicast datagrams constructed by the de-tunneling module 834/844 for the eMBMS multicast services that the user applications have subscribed.

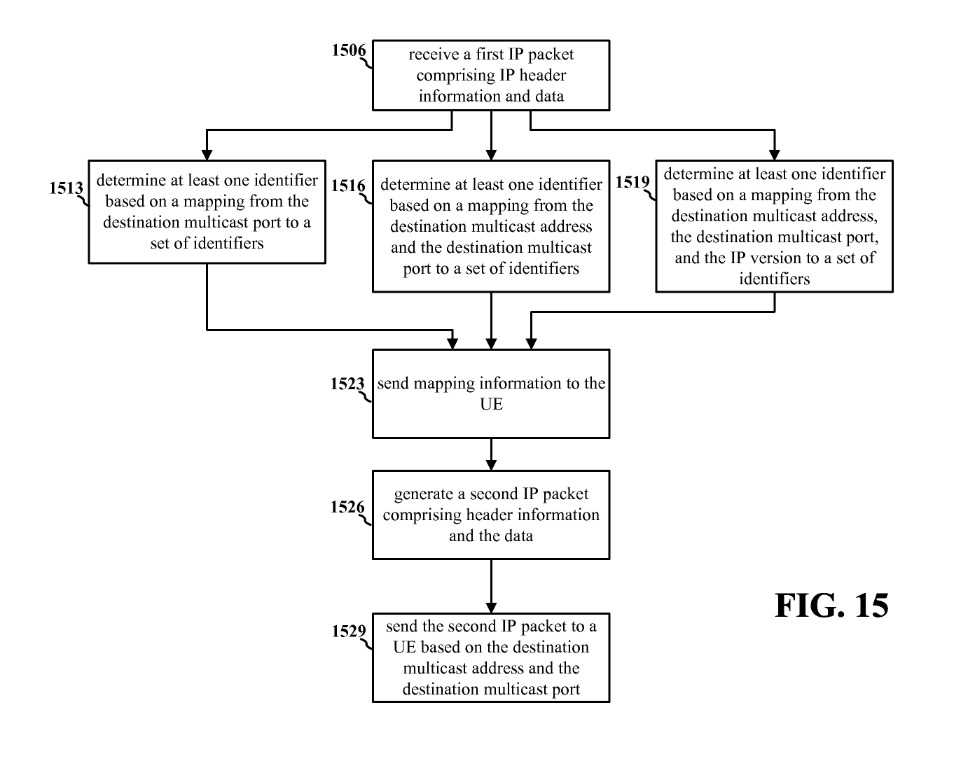

FIG. 15 is a flow chart 1500 of a method of wireless communication. The method may be performed by an apparatus (e.g., the eMBMS receiver device 820, the apparatus 1702/1702′). At operation 1506, the apparatus receives a first IP packet including IP header information and data. The IP header information includes an IP version, a destination multicast address, and a destination multicast port. For example, referring to FIG. 10, after receiving an eMBMS datagram 910 from the eMBMS modem 822 at a particular socket for the first time and optionally at other times, the tunneling module 824 processes (e.g., parses) the IP header 912 and the UDP header 914 to extract the destination IP multicast address and the destination multicast port. The tunneling module 824 can detect the IP version (e.g., IPv4 or IPv6) of the eMBMS datagram 910.

In certain configurations, the generated header information only includes the destination multicast address, the destination multicast port, and the IP version. For example, referring to FIG. 10, the header section 1011 of the tunneled packet 1020 may only include the IP version, the destination multicast address, and the destination multicast port. In certain configurations, the generated header information includes only the destination multicast port. For example, referring to FIG. 12, the identifier section 1215 of the tunneled packet 1220 may only include information indicating the destination multicast port. In certain configurations, the generated header information includes only the destination multicast address and the destination multicast port. For example, referring to FIG. 12, the identifier section 1215 of the tunneled packet 1220 may only include information indicating the destination multicast address and the destination multicast port.

In certain configurations, the information indicating the destination multicast port is a TEID based on a GPRS tunneling protocol. For example, referring to FIG. 13, the identifier section 1315 of the tunneled packet 1320 includes TEID.

In certain configurations, subsequent to operation 1506, the apparatus determines, at operation 1513, at least one identifier based on a mapping from the destination multicast port to a set of identifiers. For example, referring to FIG. 12, each identifier in the mapping table 1260, 1270 is mapped to a destination multicast port.

In certain configurations, subsequent to operation 1506, the apparatus determines, at operation 1516, at least one identifier based on a mapping from the destination multicast address and the destination multicast port to a set of identifiers. For example, referring to FIG. 12, each identifier in the mapping table 1260, 1270 is mapped to a destination multicast address and a destination multicast port.

In certain configurations, subsequent to operation 1506, the apparatus determines, at operation 1519, at least one identifier based on a mapping from the destination multicast address, the destination multicast port, and the IP version to a set of identifiers. In certain configurations, at operation 1523, the apparatus sends mapping information to the UE, the mapping information comprising a mapping from at least one of the IP version, the destination multicast address, or the destination multicast port to a set of identifiers.

At operation 1526, the apparatus generates a second IP packet comprising header information and the data, the header information comprising only information indicating at least one of the IP version, the destination multicast address, or the destination multicast port. For example, referring to FIG. 10, the tunneling module 824 constructs the header section 1011 including the IP version section 1012, the destination IP multicast address section 1013, and the destination multicast port section 1014 in an order in accordance with the associated data structure definition. The tunnel data payload 1024 includes the header section 1011 and the multicast data payload 916. In certain configurations, the generated header information includes the at least one identifier.

At operation 1529, the apparatus sends the second IP packet to a UE based on the destination multicast address and the destination multicast port. For example, referring to FIG. 10, the tunneling module 824 then transmits the tunneled packet 1020 to the eMBMS consumer devices 830, 840 that subscribed the eMBMS multicast service associated with the eMBMS datagram 910.

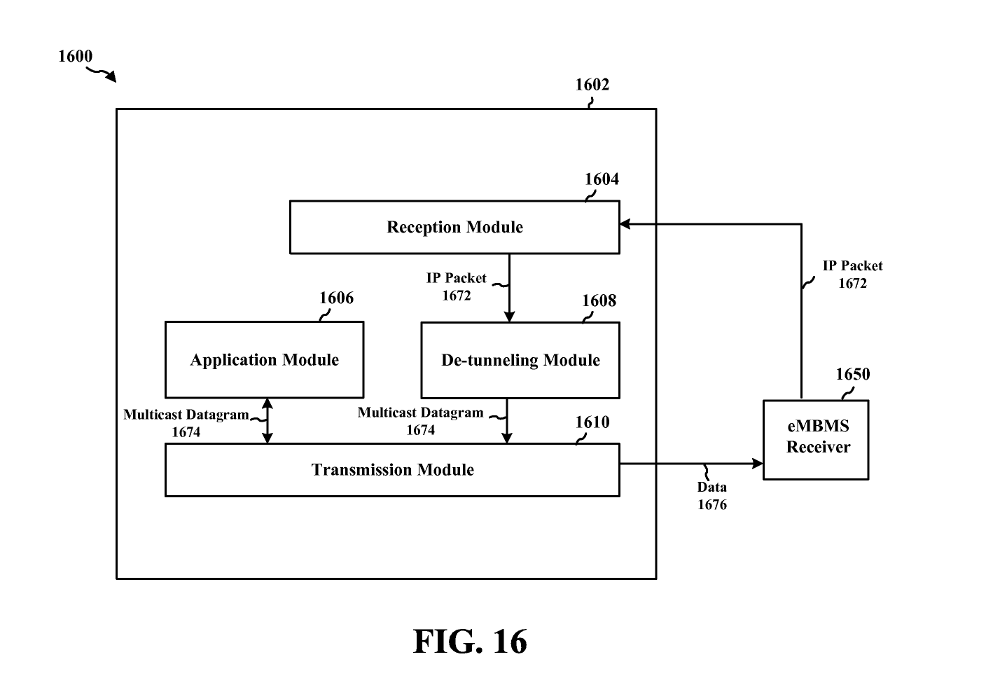

FIG. 16 is a conceptual data flow diagram 1600 illustrating the data flow between different modules/means/components in an exemplary apparatus 1602. The apparatus 1602 may be a UE. The UE includes a reception module 1604 that receives, e.g., from an eMBMS receiver 1650, an IP packet 1672 including header information and data for an MBMS session. The header information includes only information indicating at least one of an IP version, a destination multicast address of the IP packet, or a destination multicast port of the IP packet. In one configuration, the header information only includes information indicating the destination multicast port. In another configuration, the header information only includes information indicating a destination multicast address. In another configuration, the header information only includes information indicating a destination multicast address and information indicating an IP version.

The UE includes a de-tunneling module 1608. The de-tunneling module 1608 receives the IP packet 1672 from the reception module 1604. The de-tunneling module 1608 generates a multicast datagram 1674 including the data. The multicast datagram 1674 is generated based on at least one of the information indicating the destination multicast address or the information indicating the destination multicast port. The UE includes a transmission module 1610. The de-tunneling module 1608 sends the multicast datagram 1674 to the transmission module 1610. The transmission module 1610 sends the multicast datagram 1674 to an application module 1606 running on the UE. The transmission module 1610 may transmit other data 1676 of the UE (e.g., feedback) to the eMBMS receiver 1650.

In one configuration, the de-tunneling module 1608 is configured to execute an operation in which the multicast datagram 1674 is sent to the application module 1606 by locally broadcasting the received data on the destination multicast address and destination multicast port of the IP packet, and the application module 1606 receives the data by opening a multicast IP socket to listen to the destination multicast address and destination multicast port.

In one configuration, the de-tunneling module 1608 is configured to process the header information that includes only the IP version, the destination multicast address, and the destination multicast port. In one configuration, the de-tunneling module 1608 is configured to process the header information that includes only the destination multicast port. In one configuration, the de-tunneling module 1608 is configured to process the header information that includes only the destination multicast address and the destination multicast port. In one configuration, the de-tunneling module 1608 is configured to determine the IP version before receiving the IP packet.

In one configuration, the de-tunneling module 1608 is configured to process the information indicating the at least one of an IP version, a destination multicast address of the IP packet, or a destination multicast port of the IP packet that is at least one identifier, the at least one identifier being a subset of a set of identifiers. In one configuration, the de-tunneling module 1608 is configured to process the at least one identifier that is a TEID based on a GPRS tunneling protocol.

In one configuration, the de-tunneling module 1608 is configured to determine a mapping from a set of destination multicast ports to the set of identifiers and to determine the destination multicast port based on the mapping and the received at least one identifier. In one configuration, the de-tunneling module 1608 is configured to process the at least one identifier that is associated with both the destination multicast address and the destination multicast port.

In one configuration, the de-tunneling module 1608 is configured to determine a mapping from a set of destination multicast addresses and destination multicast ports to the set of identifiers and to determine the destination multicast address and the destination multicast port based on the mapping and the received at least one identifier. In one configuration, the de-tunneling module 1608 is configured to process the at least one identifier that is further associated with the IP version. The mapping is determined from a set of destination multicast addresses, destination multicast ports, and IP versions to the set of identifiers. The de-tunneling module 1608 is configured to determine the IP version based on the mapping and the received at least one identifier. In one configuration, the de-tunneling module 1608 is configured to process the IP version, the destination multicast address, and the destination multicast port that is invariant for the MBMS session.

The apparatus 1602 may include additional modules that perform each of the steps of the algorithm in the aforementioned flow chart of FIG. 14. As such, each step in the aforementioned flow chart of FIG. 14 may be performed by a module and the apparatus 1602 may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

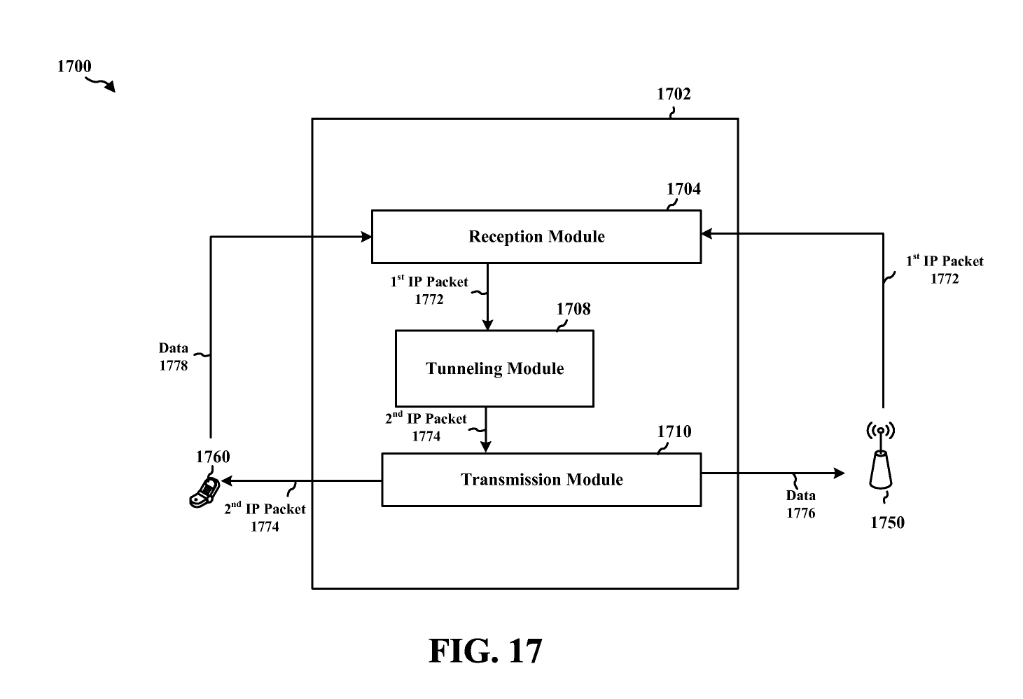

FIG. 17 is a conceptual data flow diagram 1700 illustrating the data flow between different modules/means/components in an exemplary apparatus 1702. The apparatus 1702 includes a reception module 1704 that receives, e.g., from an eNB 1750, a first IP packet 1772 including IP header information and data, the IP header information including an IP version, a destination multicast address, and a destination multicast port. The apparatus 1702 includes a tunneling module 1708. The reception module 1704 sends the first IP packet 1772 to the tunneling module 1708. The tunneling module 1708 generates a second IP packet 1774 including header information and the data. The header information includes only information indicating at least one of the IP version, the destination multicast address, or the destination multicast port. In one configuration, the header information only includes information indicating the destination multicast port. In another configuration, the header information only includes information indicating a destination multicast address. In another configuration, the header information only includes information indicating a destination multicast address and information indicating an IP version. The apparatus 1702 includes a transmission module 1710. The tunneling module 1708 sends the second IP packet 1774 to the transmission module 1710. The transmission module 1710 sends the second IP packet 1774 to a UE 1760 based on the destination multicast address and the destination multicast port. The transmission module 1710 may transmit other data 1776 of the apparatus 1702 (e.g., feedback) to the eNB 1750. The UE 1760 may transmit other data 1778 of the UE 1760 (e.g., feedback) to the apparatus 1702.

In one configuration, the tunneling module 1708 is configured to generate the header information including only the destination multicast address, the destination multicast port, and the IP version. In one configuration, the tunneling module 1708 is configured to generate the header information including only the destination multicast port. In one configuration, the tunneling module 1708 is configured to generate the header information including only the destination multicast address and the destination multicast port. In one configuration, the tunneling module 1708 is configured to determine at least one identifier based on a mapping from the destination multicast port to a set of identifiers. The header information is generated to include the at least one identifier. In one configuration, the tunneling module 1708 is configured to determine at least one identifier based on a mapping from the destination multicast address and the destination multicast port to a set of identifiers. The header information is generated to include the at least one identifier.

In one configuration, the tunneling module 1708 is configured to determine at least one identifier based on a mapping from the destination multicast address, the destination multicast port, and the IP version to a set of identifiers. The header information is generated to include the at least one identifier. In one configuration, the tunneling module 1708 is configured to use a TEID based on a GPRS tunneling protocol as the information indicating the destination multicast port. In one configuration, the transmission module 1710 is configured to send mapping information to the UE. The mapping information includes a mapping from at least one of the IP version, the destination multicast address, or the destination multicast port to a set of identifiers.

The apparatus 1702 may include additional modules that perform each of the steps of the algorithm in the aforementioned flow chart of FIG. 15. As such, each step in the aforementioned flow chart of FIG. 15 may be performed by a module and the apparatus 1702 may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

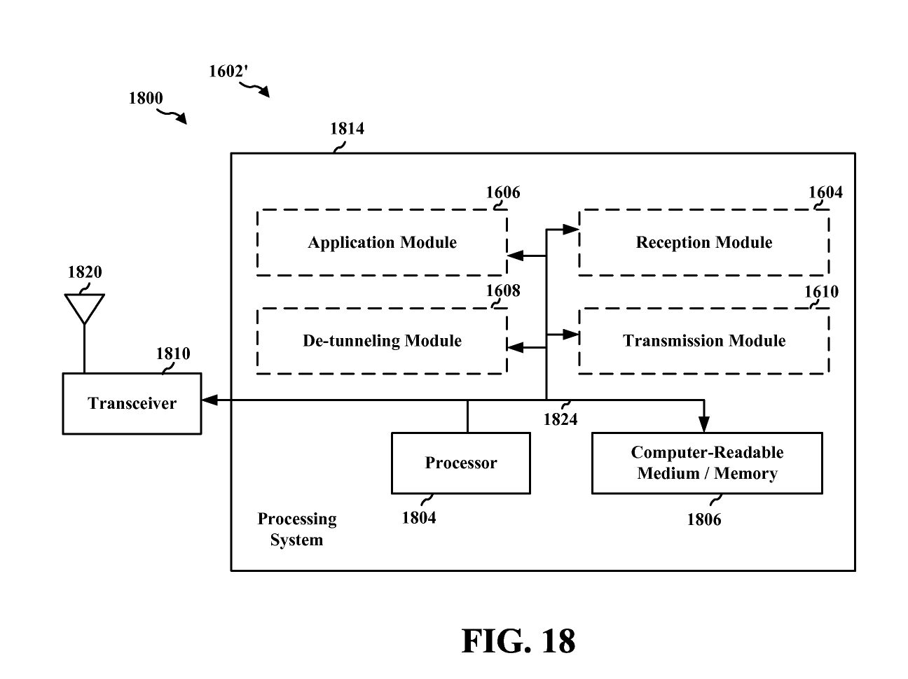

FIG. 18 is a diagram 1800 illustrating an example of a hardware implementation for an apparatus 1602′ employing a processing system 1814. The processing system 1814 may be implemented with a bus architecture, represented generally by the bus 1824. The bus 1824 may include any number of interconnecting buses and bridges depending on the specific application of the processing system 1814 and the overall design constraints. The bus 1824 links together various circuits including one or more processors and/or hardware modules, represented by the processor 1804, the modules 1604, 1606, 1608, 1610, and the computer-readable medium/memory 1806. The bus 1824 may also link various other circuits such as timing sources, peripherals, voltage regulators, and power management circuits, which are well known in the art, and therefore, will not be described any further.

The processing system 1814 may be coupled to a transceiver 1810. The transceiver 1810 is coupled to one or more antennas 1820. The transceiver 1810 provides a means for communicating with various other apparatus over a transmission medium. The transceiver 1810 receives a signal from the one or more antennas 1820, extracts information from the received signal, and provides the extracted information to the processing system 1814, specifically the reception module 1604. In addition, the transceiver 1810 receives information from the processing system 1814, specifically the transmission module 1610, and based on the received information, generates a signal to be applied to the one or more antennas 1820. The processing system 1814 includes a processor 1804 coupled to a computer-readable medium/memory 1806. The processor 1804 is responsible for general processing, including the execution of software stored on the computer-readable medium/memory 1806. The software, when executed by the processor 1804, causes the processing system 1814 to perform the various functions described supra for any particular apparatus. The computer-readable medium/memory 1806 may also be used for storing data that is manipulated by the processor 1804 when executing software. The processing system further includes at least one of the modules 1604, 1606, 1608, and 1610. The modules may be software modules running in the processor 1804, resident/stored in the computer readable medium/memory 1806, one or more hardware modules coupled to the processor 1804, or some combination thereof. The processing system 1814 may be a component of the UE 650 and may include the memory 660 and/or at least one of the TX processor 668, the RX processor 656, and the controller/processor 659.

In one configuration, the apparatus 1602/1602′ for wireless communication includes means for performing all the operations described supra with reference to FIG. 14. Particularly, the apparatus 1602/1602′ may be configured to include means for receiving an IP packet including header information and data for an MBMS session. In an aspect, the header information may include only information indicating at least one of an IP version, a destination multicast address of the IP packet, or a destination multicast port of the IP packet. The apparatus 1602/1602′ may be configured to include means for generating a multicast datagram including the data, the multicast datagram being generated based on at least one of the information indicating the destination multicast address or the information indicating the destination multicast port. The apparatus 1602/1602′ may be configured to include means for sending the multicast datagram to an application running on the UE.

In certain configurations, the multicast datagram is sent to the application by locally broadcasting the received data on the destination multicast address and destination multicast port of the IP packet. The application receives the data by opening a multicast IP socket to listen to the destination multicast address and destination multicast port. In certain configurations, the header information includes only the IP version, the destination multicast address, and the destination multicast port. In certain configurations, the header information includes only the destination multicast port. In certain configurations, the header information includes only the destination multicast address and the destination multicast port.

In certain configurations, the apparatus 1602/1602′ may be configured to include means for determining the IP version before receiving the IP packet. In certain configurations, the information indicating the at least one of an IP version, a destination multicast address of the IP packet, or a destination multicast port of the IP packet is at least one identifier, the at least one identifier being a subset of a set of identifiers. In certain configurations, the at least one identifier is a TEID based on a general packet radio service GPRS tunneling protocol.

In certain configurations, the apparatus 1602/1602′ may be configured to include means for determining a mapping from a set of destination multicast ports to the set of identifiers. The apparatus 1602/1602′ may be configured to include means for determining the destination multicast port based on the mapping and the received at least one identifier. In certain configurations, the at least one identifier is associated with both the destination multicast address and the destination multicast port. In certain configurations, the apparatus 1602/1602′ may be configured to include means for determining a mapping from a set of destination multicast addresses and destination multicast ports to the set of identifiers. The apparatus 1602/1602′ may be configured to include means for determining the destination multicast address and the destination multicast port based on the mapping and the received at least one identifier.

In certain configurations, the at least one identifier is further associated with the IP version. The mapping is determined from a set of destination multicast addresses, destination multicast ports, and IP versions to the set of identifiers. The apparatus is further configured to determine the IP version based on the mapping and the received at least one identifier. In certain configurations, the IP version, the destination multicast address, the destination multicast port is invariant for the MBMS session.

The aforementioned means may be one or more of the aforementioned modules of the apparatus 1602 and/or the processing system 1814 of the apparatus 1602′ configured to perform the functions recited by the aforementioned means. As described supra, the processing system 1814 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

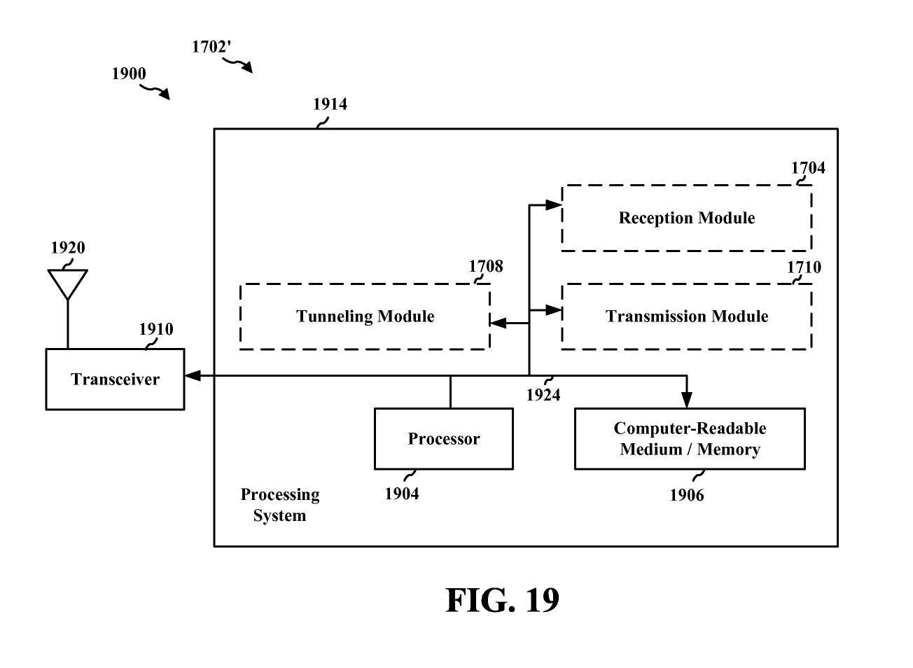

FIG. 19 is a diagram 1900 illustrating an example of a hardware implementation for an apparatus 1702′ employing a processing system 1914. The processing system 1914 may be implemented with a bus architecture, represented generally by the bus 1924. The bus 1924 may include any number of interconnecting buses and bridges depending on the specific application of the processing system 1914 and the overall design constraints. The bus 1924 links together various circuits including one or more processors and/or hardware modules, represented by the processor 1904, the modules 1704, 1708, 1710, and the computer-readable medium/memory 1906. The bus 1924 may also link various other circuits such as timing sources, peripherals, voltage regulators, and power management circuits, which are well known in the art, and therefore, will not be described any further.

The processing system 1914 may be coupled to a transceiver 1910. The transceiver 1910 is coupled to one or more antennas 1920. The transceiver 1910 provides a means for communicating with various other apparatus over a transmission medium. The transceiver 1910 receives a signal from the one or more antennas 1920, extracts information from the received signal, and provides the extracted information to the processing system 1914, specifically the reception module 1704. In addition, the transceiver 1910 receives information from the processing system 1914, specifically the transmission module 1710, and based on the received information, generates a signal to be applied to the one or more antennas 1920. The processing system 1914 includes a processor 1904 coupled to a computer-readable medium/memory 1906. The processor 1904 is responsible for general processing, including the execution of software stored on the computer-readable medium/memory 1906. The software, when executed by the processor 1904, causes the processing system 1914 to perform the various functions described supra for any particular apparatus. The computer-readable medium/memory 1906 may also be used for storing data that is manipulated by the processor 1904 when executing software. The processing system further includes at least one of the modules 1704, 1708, and 1710. The modules may be software modules running in the processor 1904, resident/stored in the computer readable medium/memory 1906, one or more hardware modules coupled to the processor 1904, or some combination thereof. The processing system 1914 may be a component of the UE 650 and may include the memory 660 and/or at least one of the TX processor 668, the RX processor 656, and the controller/processor 659.

In one configuration, the apparatus 1702/1702′ for wireless communication includes means for performing all the operations described supra with reference to FIG. 15. Particularly, the apparatus 1702/1702′ may be configured to include means for receiving a first Internet protocol (IP) packet including IP header information and data, the IP header information including an IP version, a destination multicast address, and a destination multicast port. The apparatus 1702/1702′ may be configured to include means for generating a second IP packet including header information and the data, the header information including only information indicating at least one of the IP version, the destination multicast address, or the destination multicast port. The apparatus 1702/1702′ may be configured to include means for sending the second IP packet to a user equipment (UE) based on the destination multicast address and the destination multicast port.

In certain configurations, the generated header information includes only the destination multicast address, the destination multicast port, and the IP version. In certain configurations, the generated header information includes only the destination multicast port. In certain configurations, the generated header information includes only the destination multicast address and the destination multicast port.

In certain configurations, the apparatus 1702/1702′ may be configured to include means for determining at least one identifier based on a mapping from the destination multicast port to a set of identifiers. In certain configurations, the apparatus 1702/1702′ may be configured to include means for determining at least one identifier based on a mapping from the destination multicast address and the destination multicast port to a set of identifiers. In certain configurations, the apparatus 1702/1702′ may be configured to include means for determining at least one identifier based on a mapping from the destination multicast address, the destination multicast port, and the IP version to a set of identifiers. In certain configurations, the information indicating the destination multicast port is a TEID based on a GPRS tunneling protocol. In certain configurations, the apparatus 1702/1702′ may be configured to include means for sending mapping information to the UE, the mapping information including a mapping from at least one of the IP version, the destination multicast address, or the destination multicast port to a set of identifiers.

The aforementioned means may be one or more of the aforementioned modules of the apparatus 1702 and/or the processing system 1914 of the apparatus 1702′ configured to perform the functions recited by the aforementioned means. As described supra, the processing system 1914 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication of a user equipment (UE), comprising:
receiving an Internet protocol (IP) packet including header information and data for a Multimedia Broadcast Multicast Service (MBMS) session, the header information comprising only information indicating at least one of an IP version, a destination multicast address of the IP packet, or a destination multicast port of the IP packet;
generating a multicast datagram including the data, the multicast datagram being generated based on at least one of the information indicating the destination multicast address or the information indicating the destination multicast port; and
sending the multicast datagram to an application running on the UE.

2. The method of claim 1, wherein the multicast datagram is sent to the application by locally broadcasting the received data on the destination multicast address and destination multicast port of the IP packet, and the application receives the data by opening a multicast IP socket to listen to the destination multicast address and destination multicast port.

3. The method of claim 1, wherein the header information includes only the IP version, the destination multicast address, and the destination multicast port.

4. The method of claim 1, wherein the header information includes only the destination multicast port.

5. The method of claim 1, wherein the header information includes only the destination multicast address and the destination multicast port.

6. The method of claim 1, further comprising determining the IP version before receiving the IP packet.

7. The method of claim 1, wherein the information indicating the at least one of an IP version, a destination multicast address of the IP packet, or a destination multicast port of the IP packet is at least one identifier, the at least one identifier being a subset of a set of identifiers.

8. The method of claim 7, wherein the at least one identifier is a tunnel endpoint identifier (TEID) based on a general packet radio service (GPRS) tunneling protocol.

9. The method of claim 7, further comprising:
determining a mapping from a set of destination multicast ports to the set of identifiers; and
determining the destination multicast port based on the mapping and the received at least one identifier.

10. The method of claim 7, wherein the at least one identifier is associated with both the destination multicast address and the destination multicast port.

11. The method of claim 10, further comprising:
determining a mapping from a set of destination multicast addresses and destination multicast ports to the set of identifiers; and
determining the destination multicast address and the destination multicast port based on the mapping and the received at least one identifier.

12. The method of claim 11, wherein the at least one identifier is further associated with the IP version, wherein the mapping is determined from a set of destination multicast addresses, destination multicast ports, and IP versions to the set of identifiers, and wherein the method further comprises determining the IP version based on the mapping and the received at least one identifier.

13. The method of claim 1, wherein the IP version, the destination multicast address, the destination multicast port is invariant for the MBMS session.

14. An apparatus for wireless communication, the apparatus being a user equipment (UE), comprising:
means for receiving an Internet protocol (IP) packet including header information and data for a Multimedia Broadcast Multicast Service (MBMS) session, the header information comprising only information indicating at least one of an IP version, a destination multicast address of the IP packet, or a destination multicast port of the IP packet;
means for generating a multicast datagram including the data, the multicast datagram being generated based on at least one of the information indicating the destination multicast address or the information indicating the destination multicast port; and
means for sending the multicast datagram to an application running on the UE.

15. The apparatus of claim 14, wherein the multicast datagram is sent to the application by locally broadcasting the received data on the destination multicast address and destination multicast port of the IP packet, and the application receives the data by opening a multicast IP socket to listen to the destination multicast address and destination multicast port.

16. The apparatus of claim 14, wherein the header information includes only the IP version, the destination multicast address, and the destination multicast port.

17. The apparatus of claim 14, wherein the header information includes only the destination multicast port.

18. The apparatus of claim 14, wherein the header information includes only the destination multicast address and the destination multicast port.

19. The apparatus of claim 14, further comprising means for determining the IP version before receiving the IP packet.

20. The apparatus of claim 14, wherein the information indicating the at least one of an IP version, a destination multicast address of the IP packet, or a destination multicast port of the IP packet is at least one identifier, the at least one identifier being a subset of a set of identifiers.

21. The apparatus of claim 20, wherein the at least one identifier is a tunnel endpoint identifier (TEID) based on a general packet radio service (GPRS) tunneling protocol.

22. The apparatus of claim 20, further comprising:
means for determining a mapping from a set of destination multicast ports to the set of identifiers; and
means for determining the destination multicast port based on the mapping and the received at least one identifier.

23. The apparatus of claim 20, wherein the at least one identifier is associated with both the destination multicast address and the destination multicast port.

24. The apparatus of claim 23, further comprising:
means for determining a mapping from a set of destination multicast addresses and destination multicast ports to the set of identifiers; and
means for determining the destination multicast address and the destination multicast port based on the mapping and the received at least one identifier.

25. The apparatus of claim 24, wherein the at least one identifier is further associated with the IP version, wherein the mapping is determined from a set of destination multicast addresses, destination multicast ports, and IP versions to the set of identifiers, and wherein the apparatus further comprises determining the IP version based on the mapping and the received at least one identifier.

26. The apparatus of claim 14, wherein the IP version, the destination multicast address, the destination multicast port is invariant for the MBMS session.

27. An apparatus for wireless communication, the apparatus being a user equipment (UE), comprising:
a memory; and
at least one processor coupled to the memory and configured to:
receive an Internet protocol (IP) packet including header information and data for a Multimedia Broadcast Multicast Service (MBMS) session, the header information comprising only information indicating at least one of an IP version, a destination multicast address of the IP packet, or a destination multicast port of the IP packet;
generate a multicast datagram including the data, the multicast datagram being generated based on at least one of the information indicating the destination multicast address or the information indicating the destination multicast port; and
send the multicast datagram to an application running on the UE.

28. The apparatus of claim 27, wherein the multicast datagram is sent to the application by locally broadcasting the received data on the destination multicast address and destination multicast port of the IP packet, and the application receives the data by opening a multicast IP socket to listen to the destination multicast address and destination multicast port.

29. The apparatus of claim 27, wherein the header information includes only the IP version, the destination multicast address, and the destination multicast port.

30. A computer-readable medium storing computer executable code for wireless communication at a user equipment (UE), comprising code for:
receiving an Internet protocol (IP) packet including header information and data for a Multimedia Broadcast Multicast Service (MBMS) session, the header information comprising only information indicating at least one of an IP version, a destination multicast address of the IP packet, or a destination multicast port of the IP packet;
generating a multicast datagram including the data, the multicast datagram being generated based on at least one of the information indicating the destination multicast address or the information indicating the destination multicast port; and
sending the multicast datagram to an application running on the UE.
